(19) United States
(12) Patent Application Publication
(10) Pub. No.: US 2009/0046875 A1
(43) Pub. Date: Feb. 19, 2009

(54) SPEAKER DEVICE

(76) Inventor: Tadashi Masuda, Aichi (JP)

Correspondence Address: COOPER & DUNHAM, LLP, 30 Rockefeller Plaza, 20th Floor, NEW YORK, NY, 10112, US

(21) Appl. No.: 12/158,010

(22) PCT Filed: Dec. 20, 2006
(86) PCT No.: PCT/JP2006/325382

§ 371 Date: Jun. 18, 2008

(30) Foreign Application Priority Data
Dec. 22, 2005 (JP) 2005-368965

(51) Int. Cl. H04R 25/00

(52) U.S. Cl. 381/152

(57) ABSTRACT

To provide a speaker system in which arrival times of sounds radiated from each speaker are aligned, sound pressures of speakers other than a woofer are enhanced as in a horn-type speaker, and each speaker unit, which disperses with a conventional horn, is gathered to integrate functions of each speaker and present a balanced appearance.

Two or more types of speakers 3, 4, 5 including a reference speaker 4 for reproducing a high frequency range next to a reproduction range of a woofer 3 are arranged in line and a pair of enhanced walls 10a is disposed on a front face of a baffle board 2 to pass by left and right sides of a radiating face of the reference speaker 4, vertically extend along the front face of the baffle board 2, and open left and right toward forward. Accordingly, the radiated sound from the reference speaker 4 is enhanced by an inside space of the pair of enhanced walls 10a without enhancing the radiated sound from the woofer 3.

### FIELD OF THE INVENTION

The present invention relates to a speaker device in which two or more types of speaker with a different reproduction range are arranged in line on a baffle board.

### BACKGROUND ART

A most typical speaker device having two or more types of speaker with a different reproduction range arranged in line on a baffle board includes three types of speaker respectively for high frequency range, middle frequency range, and low frequency range, which constitute a three-way speaker system. There are other speaker systems that constitute a four-way speaker system or more. Further, there is another speaker system including an additional speaker device having a speaker for reproducing the low frequency range.

Generally, a speaker which constitutes a speaker system is called differently according to its reproduction range. In a three-way system, from a speaker of low frequency range, speakers are called woofer, squawker and tweeter. In a four-way system, from low frequency range, they are called woofer, mid-bass, squawker and tweeter. An arrangement in which a squawker and a woofer are symmetrically arranged with respect to a tweeter in a vertical direction is called virtual coaxial arrangement. Hereinafter, these names will be used.

A horn-type speaker with a horn in its driver unit has superb transient response characteristics and creates an articulate sound. Therefore, it is adopted in many speaker devices. However, a horn-type woofer requires a huge horn. Accordingly, in a general speaker device, a direct radiation type speaker is employed as a woofer while a horn-type is employed as tweeter and squawker other than woofer.

Meanwhile, in a speaker system including two or more types of speaker, it is desirable to remove aural misalignment between each speaker. In order to remove such “misalignment,” there are several methods that are supposed to be preferable: an “in-line arrangement” in which each speaker is aligned on a center line in a vertical direction; the “virtual coaxial arrangement” described above; an “arrangement with aligned sound sources in a fore-and-aft direction” in which arrival time of sound radiated from each speaker is aligned; and an “arrangement with adjusted sound sources in a fore-and-aft direction” in which phase shift caused by characteristics of each speaker and dividing network is compensated.

However, in most of speaker devices having horn-type speakers except for a woofer, although each speaker is arranged in line, arrival time of sound radiated from each speaker is not aligned (Patent Document 1, for example). This is because, when a sound source of each speaker is aligned in a fore-and-aft direction to eliminate differences between arrival times of sounds radiated from each speaker, a front-end of a long horn of a midrange speaker protrudes, the long horn of the midrange speaker being hit by sounds radiated from a short-horn speaker for high frequency range and a direct radiation type woofer, thereby causing distortion by reflection. Also, the protruded horn of the midrange speaker makes an appearance of the whole speaker device unbalanced. On the other hand, there are speaker devices that employ an arrangement with aligned sound sources of each speaker in a fore-and-aft direction and an arrangement with adjusted sound sources in a fore-and-aft direction. In any case, speaker systems having horn-type speakers except for a woofer overlook such a harmful effect.

[Patent Document 1]

JP-A-Hei 9-135489 (FIG. 19)

### DISCLOSURE OF THE INVENTION

### Problem to be Solved by the Invention

As described above, in most of speaker devices having horn-type speakers except for a woofer, if each speaker is arranged to eliminate differences between arrival times of sounds radiated from each speaker, harmful effects are produced in terms of acoustic characteristics and design. Accordingly, the arrival times of sounds radiated from each speaker are deviated. The present invention has been made in view of the foregoing situation and the object of the invention is to provide a speaker device in which arrival times of sounds radiated from each speaker are aligned, sound pressures of speakers other than a woofer are enhanced, and each speaker is closely arranged to present a balanced appearance.

### Means for Solving the Problem

In order to solve the problem, the inventor verified enhancement and differences in arrival times of radiated sounds from each speaker by changing arrangement of each speaker in a speaker device, shapes of horns, and the like. The inventor found that radiated sounds from a speaker for middle frequency range and the like can be enhanced as in a horn-type and differences between the arrival times can be improved by providing a pair of enhanced walls in a predetermined shape in front of a baffle board, which achieves the present invention.

The present invention is a speaker device in which two or more types of speaker with a different reproduction range are arranged in line on a baffle board characterized in that: a reference speaker for reproducing a high frequency range next to a reproduction range of a woofer is provided on the baffle board; and a pair of enhanced walls is provided on the front side of the baffle board in such a manner that the pair of enhanced walls stretches along both sides of a radiating face of the reference speaker and both sides of all the speakers other than the reference speaker, extends vertically on the front face of the baffle board, opens left and right toward the forward of the baffle and forms a shape to enhance a radiated sound from the reference speaker.

Here, the “reference speaker” for reproducing a high frequency range next to a reproduction range of a woofer is a squawker in a speaker device forming a three-way speaker system and is a mid-bass in a speaker system forming a four-way speaker system. Though a speaker device according to the present invention is applied to a speaker system having a woofer and configured to be three-way or more, the woofer is not necessarily disposed on the baffle board. That is, the speaker device according to the present invention includes a speaker system having two or more types of speaker other than a woofer to form a speaker system combined with another speaker device having a woofer.

In such a configuration, the radiated sound from the reference speaker is radiated inside the pair of enhanced walls opening left and right in the forward of the radiating face and enhanced in this inside space. In addition, when the minimum distance through which the radiated sound from the reference speaker reaches an upper end of the pair of enhanced walls and the minimum distance through which the radiated sound from the reference speaker reaches a lower end of the pair of enhanced walls are generally equal to or longer than the minimum distance through which the radiated sound from the reference speaker reaches a front-end of the pair of enhanced walls, effective enhancement of sound pressure, which falls short of the effect in an ideal full-sized horn but equals to the effect in a practical full-sized horn, is obtained.

In the present invention, the pair of enhanced walls is disposed vertically along a front face of the baffle board and all the speakers mounted on the baffle board are arranged in line. Therefore, the pair of enhanced walls extending vertically along the front face of the baffle board passes by both sides of the radiating faces of all the speakers. Accordingly, in the speaker device of the present invention, the radiated sounds from all the speakers are radiated into the inside space of the pair of enhanced walls. Here, since the pair of enhanced walls opens left and right toward forward, the radiated sounds from a speaker for high frequency range and from a speaker for low frequency range are radiated into a forward listening space while being combined with the radiated sound from the reference speaker in the inside space of the pair of enhanced walls without being hit and reflected by the pair of enhanced walls.

Thus, in the speaker device of the present invention, the radiated sound from the “reference speaker” for reproducing a high frequency range next to the reproduction range of the woofer is enhanced by the pair of enhanced walls to have similar acoustics to the horn. Nevertheless, since the pair of enhanced walls is not horizontally partitioned, an inner wall surface is formed also along a radiating direction of sound waves from other speakers. Therefore, if the sound sources of the other speakers are aligned with the sound source of the reference speaker in a fore-and-aft direction, the radiated sounds from the other speakers do not hit the pair of enhanced walls and are not reflected as in a horn-type speaker. The pair of enhanced walls, being different from the horn locally protruding forward, stretches vertically along the front face of the baffle board. Therefore, a front-side shape of the speaker device of the present invention is balanced with less projection.

Incidentally, in the present invention, when a woofer is disposed on the baffle board, sound pressure enhancement effect of the pair of enhanced walls affects a high frequency part of the radiated sound from the woofer and thereby disturbs flatness of the sound pressure characteristics of the woofer. In contrast, in the configuration described above, the following configuration is proposed: a woofer is disposed on the baffle board, outer vacancies opening toward the listening space are formed between outer walls of the pair of enhanced walls and the front face of the baffle board, and enhancement suppression gaps are formed in the both side vicinities of the radiating face of the woofer to radiate the radiated sound from the woofer into the outer vacancies.

In the above configuration, the radiated sound from the woofer is radiated through the enhancement suppression gaps, then through the outer vacancies toward the listening space. Therefore, an acoustic load of the pair of enhanced walls applied on the radiated sound from the woofer is reduced, which flattens the sound pressure characteristics of the woofer.

On the other hand, in the present invention, when a speaker for high frequency range (tweeter, squawker on a four-way speaker system, etc.) for reproducing a higher frequency range than that of the reference speaker is provided on the baffle board, the following configuration is proposed: a pair of enhanced walls for high frequency range is disposed inside the pair of enhanced walls in the both side vicinities of the radiating face of the speaker for high frequency range to open left and right toward forward and form in a shape to enhance the radiated sound from the speaker for high frequency range, and the upper, the lower and the front ends of the pair of enhanced walls for high frequency range are jointed with inner walls of the pair of enhanced walls. Here, it is preferable that the dimension between the upper and the lower ends of the pair of enhanced walls for high frequency range is shorter than twice the distance between the upper end of the radiating face of a neighboring speaker for reproducing a lower frequency range and the center of the speaker for high frequency range, and the dimension between the rear end and the front end of the pair of enhanced walls for high frequency range is about a half of the dimension between the upper and the lower ends of the pair of enhanced walls for high frequency range. It is also preferable that the upper, the lower and the front ends of the inner wall surfaces of the pair of enhanced walls for high frequency range are smoothly jointed with the inner wall surfaces of the pair of enhanced walls so that the radiated sound from each of speakers proceeds along these ends and does not distort at the jointed portions.

When a horn-type tweeter for reproducing a higher frequency range than that of the reference speaker is provided on the baffle board, the following configuration is proposed: both sides of the front end of a horn of the horn-type tweeter are jointed with the inner walls of the pair of enhanced walls in such a manner that inner walls of the both sides of the horn are smoothly jointed with the inner walls of the pair of enhanced walls so that the radiated sound from the horn-type tweeter does not hit and reflect at the jointed portions and does not distort. In the above configuration, it is preferable that outer walls of the horn are designed to form along the radiating direction of a neighboring speaker so that the radiated sound from the speaker does not hit them and does not reflect. Meanwhile, the horn-type tweeter is defined as a tweeter composed of a dome-type speaker or a compression driver provided with a horn for enhancing the radiated sound from the tweeter. Also, when a speaker for high frequency range for reproducing a higher frequency range than that of the reference speaker is disposed on the baffle board, the following configuration is further proposed: inner walls of the pair of enhanced walls pass by both side edges of the radiating face of the speaker for high frequency range and form in a shape to enhance the radiated sound from the speaker for high frequency range.

The following configuration is also proposed: a horn-type tweeter for reproducing a higher frequency range than that of the reference speaker is provided on the baffle board, and directivity widening gaps are formed in the both side vicinities of an opening of the horn of the horn-type tweeter to pass the radiated sound from the horn-type tweeter outside the pair of enhanced walls and radiate it into the listening space.

In the above configuration, the radiated sound wave from the horn-type tweeter is also radiated outside the pair of enhanced walls through the directivity widening gaps. Thereby, a relatively narrow directivity of high frequency range sound can be broadened. The directivity widening gap with a wider opening passes the radiated sound more and thereby broadens directivity of the radiated sound. On the other hand, the directivity widening gap with a wider opening decreases the radiated sound passing inside the pair of enhanced walls. Therefore, it is preferable to set a size of the opening of the directivity widening gap corresponding to the characteristics of the speaker.

In the above configuration, when the reference speakers are arranged virtually coaxial respectively above and below the horn-type tweeter, the horn of the tweeter is apt to protrude forward of the baffle board. In the above configuration, when the opening of the horn of the tweeter is protruded up to the front end of the pair of enhanced walls, the sound pressure enhancement effect around the cut-off frequency is adapted to be the extent of effect given by the one piece of the pair of enhanced walls vertically divided by the horn. This causes a harmful effect in which a sufficient acoustic load down to the assumed low frequency range is not applied on the reproducing frequency range of the reference speakers.

Such a harmful effect begins to be reduced if the opening of the horn of the tweeter is disposed behind the front end of the pair of enhanced walls by a distance about 30% of the vertical dimension of the opening of the horn. The harmful effect is apparently improved if the opening is disposed behind the front end of the pair of enhanced walls by a distance more than 50% of the vertical dimension of the opening of the horn. And the harmful effect becomes substantially small if the opening is disposed behind the front end of the pair of enhanced walls by a distance more than 70% of the vertical dimension of the opening of the horn.

As a result, in the present invention, the configuration is proposed as follows: the horn-type tweeter, which reproduces a higher frequency range than that of the reference speaker, is disposed on the baffle board; the reference speakers are arranged virtually coaxial respectively above and below the tweeter; and the opening of the horn of the tweeter is disposed behind the front end of the pair of enhanced walls by a distance more than a half of the vertical dimension of the opening. Here, “the vertical dimension of the opening of the horn” is not an inside vertical dimension of the opening of the horn but a vertical dimension including thicknesses of upper and lower side plates.

### EFFECT OF THE INVENTION

As described above, the present invention provides a speaker device in which a pair of enhanced walls is disposed on a front face of a baffle board to pass by left and right sides of the radiating faces of a reference speaker and speakers other than the reference speaker, vertically extend along the front face of the baffle board and open left and right toward forward, and the radiated sound from the reference speaker is enhanced by the pair of enhanced walls. Therefore, the sound pressure enhancement effect on the radiated sound from the reference speaker can be obtained as in a case of a full-sized horn based on the horn theory.

The radiated sounds from all the speakers are radiated into an inside space of the pair of enhanced walls. Therefore, even though a woofer and a speaker for high frequency range are closely disposed above and below the reference speaker and each location of sound sources of the speakers is adjusted in a fore-and-aft direction to equalize each of arrival times of the radiated sounds, the radiated sounds from speakers for high and low frequency ranges can be radiated into a listening space without hitting the horn of a speaker for middle frequency range and being distorted as in a conventional horn-type speaker device.

Further, in the conventional horn-type speaker device, since the speakers for high, middle, and low frequency ranges are disposed outside openings of the respective horns, the radiated sounds from each of the speakers tend to disperse and thereby become unrealistic. In contrast, in the present invention, since each speaker is closely disposed around a central portion inside the pair of enhanced walls and the radiated sounds from each of the speakers are mixed in the inside space of the pair of enhanced walls to be radiated into the listening space from the front end of the pair of enhanced walls, the radiated sounds from each of the speakers tend to gather together and thereby become realistic.

That is, in the speaker device of the present invention, sound pressure enhancement is obtained as in the horn-type speaker device, the arrival times of the radiated sounds from the woofer to the tweeter are aligned, and each of the speakers are closely disposed to achieve realistic acoustics. Further, there is a multiple advantage in which a compact and balanced appearance can be realized in addition to such excellent acoustic characteristics.

Also, enhancement suppression gaps are formed in the both side vicinities of the radiating face of the woofer to radiate the radiated sound from the woofer through outer vacancies into the listening space. Therefore, the radiated sound from the woofer can be prevented from being partially enhanced by the pair of enhanced walls and flat frequency characteristics of the woofer can be realized.

When the directivity widening gaps are formed in the both side vicinities of an opening of a horn of a horn-type tweeter to pass the radiated sound from the horn-type tweeter outside the pair of enhanced walls and radiate it into the listening space, directivity of the reproduced sound of the horn-type tweeter can be broadened.

Further, in the configuration in which the reference speakers are arranged virtually coaxial above and below the tweeter, when the opening of the horn of the tweeter is disposed behind the front end of the pair of enhanced walls by a distance more than a half of the vertical dimension of the opening, the sound pressure enhancement effect of the pair of enhanced walls can be prevented from reducing around the cut-off frequency by the horn.

### BEST MODE FOR CARRYING OUT THE INVENTION

A description will hereinafter be made of an embodiment of the present invention with reference to each example.

### First Embodiment

FIG. 1 is a perspective view of a speaker device 1 according to a first embodiment. The speaker device 1 includes two types of speaker respectively one for each type, a squawker 4 and a tweeter 5. The speaker device 1 is combined with another speaker device (not shown) including a woofer to constitute a three-way speaker system. That is, in the speaker device 1 of the first embodiment, the squawker 4 is a reference speaker according to the present invention.

As shown in FIGS. 1 to 4, the speaker device 1 according to the embodiment includes a rectangular baffle board 2. The baffle board 2 is made of plywood and its dimensions are: 40 cm (width)×82 cm (height)×18 mm (thickness). A rectangular opening 9a is formed in the middle of the baffle board 2. The squawker 4 is attached to the opening 9a from the back side. The squawker 4 is a corn-type full-range speaker in 18 cm diameter. The backside of the squawker 4 is surrounded by a closed-type cabinet 11 with an inner volume of 16 liters.

A rectangular opening 9b is formed in an upper part of the baffle board 2. The tweeter 5 is attached to the opening 9b from the back side. The tweeter 5 is a dome-type speaker in 28 mm diameter. Here, as shown FIGS. 1 and 2, the squawker 4 and the tweeter 5 are arranged in line. In addition, the squawker 4 and the tweeter 5 are arranged in such a manner that respective sound sources are aligned in a fore-and-aft direction.

As shown in FIGS. 1 to 4, a pair of enhanced walls 10 is disposed on a front face of the baffle board 2 in such a manner that the pair of enhanced walls 10 covers left and right parts of a radiating face of the squawker (reference speaker) 4, extends vertically along the front face of the baffle board 2 and opens left and right toward forward. The pair of enhanced walls 10 is made up of two pieces of curved plywood in 18 mm thickness. A section of the pair of enhanced walls 10 is such that its inner wall surfaces open left and right in the same curved shape as plywood members 13c, 13d that constitute a horn 13 shown in FIG. 5 as a first comparative example. Dimensions of the pair of enhanced walls 10 are: 38 cm (opening width)×82 cm (height)×27 cm (depth). The pair of enhanced walls 10 is designed on the assumption that the throat area of the horn is 135 cm² and the cut-off frequency of the horn is 270 Hz. The radiated sound of the squawker 4 is enhanced in an inside space of the pair of enhanced walls 10 as described later.

Further, a pair of enhanced walls for high frequency range 12 is disposed on the front face of the baffle board 2 at an attachment part of the tweeter 5 in a shape capable of enhancing the radiated sound from the tweeter 5. The pair of enhanced walls for high frequency range 12 is adapted to exclusively enhance the radiated sound from the tweeter 5 and therefore is different from the pair of enhanced wall according to the present invention. The pair of enhanced walls for high frequency range 12 is made of plywood and its dimensions are: 12 cm (depth)×28 cm (height)×3 cm (thickness). The pair of enhanced walls for high frequency range 12 is positioned inside the pair of enhanced walls 10 to enhance the radiated sound from the tweeter 5 with inner wall surfaces opening left and right toward forward. Upper, lower and front ends of the inner wall surfaces of the pair of enhanced walls for high frequency range 12 are smoothly jointed with the inner wall surfaces of the pair of enhanced walls 10 in such a manner that the radiated sounds from the squawker 4 and the tweeter 5 smoothly proceed along these ends. Therefore, the radiated sounds from the squawker 4 and the tweeter 5 do not hit the pair walls 10, 12 at joints thereof and do not distort by reflection.

### First Comparative Example

FIG. 5 shows a speaker device 1a as a first comparative example, which is used for performance verification of the speaker device 1 of the first embodiment. The speaker device 1a includes a same cone-type speaker as the squawker 4 in the first embodiment and enhances its radiated sound with a horn 13.

The horn 13 is a full-sized exponential horn, in which the throat area is 135 cm², the opening area is 1,750 cm², the distance from the throat to the opening is 27 cm and the cut-off frequency is 270 Hz. The horn 13 is made of plywood having the same material and the same thickness as the pair of enhanced walls 10 in the first embodiment. Plywood members 13a, 13b are a flat board, which constitute upper and lower parts of the horn 13 and are disposed at an angle of approximately 30 degrees with respect to a horizontal plane to open toward forward. The plywood members 13c, 13d constitute left and right parts of the horn 13 and are formed in an exponential curve. A throat 13e of the horn 13 is rectangular in shape and its dimensions are 9 cm wide and 15 cm high. The squawker 4 is attached to the throat 13e from backside. The backside of the squawker 4 is surrounded by a closed-type cabinet 11a with an inner volume of 16 liters.

### Second Comparative Example

Removing the horn 13 from the speaker device 1a as the first comparative example makes a speaker device (not shown) of a second comparative example. That is, the speaker device of the second comparative example is configured such that only the backside of the squawker 4 according to the first embodiment is surrounded by a closed-type cabinet 11a with an inner volume of 16 liters as in the first embodiment.

[Test 1]

The frequency characteristics of the squawker 4 were checked for each of the speaker devices of the first embodiment, the first comparative example and the second comparative example. A measuring microphone was set at a height of 1 m and positioned 1 m forward of the averaged diaphragm position of the squawker 4. Test results are shown in FIG. 6.

In comparison of the frequency characteristics between the first comparative example and the second comparative example, the sound pressure level of the first comparative example exceeds that of the second comparative example from just above 100 Hz and for outweighs the second comparative example in 300 through 1,000 Hz. The difference of the sound pressure levels shows the effect of sound pressure enhancement of the radiated sound from the squawker 4 by the horn 13 in the first comparative example.

Meanwhile, in comparison of the frequency characteristics between the first embodiment and the second comparative example, the sound pressure level of the first embodiment, in the same manner as in the first comparative example, exceeds that of the second comparative example from just above 100 Hz and outweighs the second comparative example in 300 through 1,000 Hz. This result means that the pair of enhanced walls 10 in the first embodiment enhances the radiated sound from the squawker 4. In comparison of the effect of sound pressure enhancement between the pair of enhanced walls 10 in the first embodiment and the horn 13 in the first comparative example, nearly equal level of sound pressure enhancement is found in the range 400 Hz or lower and the first comparative example outweighs the first embodiment by 3 to 5 dB in 400 through 1,500 Hz of sound range.

Thus, although the speaker device 1 of the first embodiment does not reach the full-sized horn 13 based on the theoretical calculation, the speaker device 1 realizes sound pressure enhancement with the effect of sound pressure enhancement by the pair of enhanced walls 10 as much as the full-sized horn does. In order to effectively enhance the radiated sound from the squawker 4 (reference speaker) by the pair of enhanced walls 10, it is preferable that the minimum distance through which the radiated sound from the squawker 4 reaches the upper and the lower ends of the pair of enhanced walls 10 is generally equal to or longer than the minimum distance through which the radiated sound from the squawker 4 reaches the front end of the pair of enhanced walls 10. In other words, it is preferable that the distances from the upper and the lower ends of the radiating face of the squawker 4 to the upper and the lower ends of the pair of enhanced walls 10 are equal to or longer than the distance from the radiating face of the squawker 4 to the front end of the pair of enhanced walls 10. In this case, when the reference speaker is positioned center of the speaker device, the upper and the lower ends of the pair of enhanced walls 10 are aligned to the upper and the lower ends of the baffle board of the general speaker system.

### Third Comparative Example

Removing the pair of enhanced walls 10 and the pair of enhanced walls for high frequency range 12 from the speaker device 1 of the first embodiment makes a speaker system (not shown) of a third comparative example.

[Test 2]

The frequency characteristics were checked for each of the speaker systems of the first embodiment and the third comparative example, in which the crossover frequency between the squawker 4 and the tweeter 5 is set to 1,500 Hz. The measuring microphone was set in the forward of the squawker 4 at the same conditions as Test 1. Test results are shown in FIG. 7.

As clearly shown in FIG. 7, the sound pressure of the speaker device 1 of the first embodiment is enhanced in a range from the middle frequency range to the high frequency range compared with the speaker system of the third comparative example. The radiated sound from the tweeter 5 together with the radiated sound from the squawker 4 are enhanced.

As described above, in the speaker device 1 according to the embodiment, the radiated sounds from the squawker 4 (reference speaker) and the tweeter 5 are enhanced by the pair of enhanced walls 10 and the pair of enhanced walls for high frequency range 12. Therefore, a similar tone quality to the radiated sound from the horn-type speaker can be obtained for these radiated sounds. The pair of enhanced walls 10 extends vertically along the left and the right sides of the radiating faces of each of speakers 4, 5 and the upper, the lower and the front ends of the inner wall surfaces of the pair of enhanced walls for high frequency range 12 are smoothly jointed with the inner wall surfaces of the pair of enhanced walls 10 in such a manner that the radiated sounds from the squawker 4 and the tweeter 5 smoothly proceed along these ends. Therefore, if the tweeter 5 is disposed closely above the squawker 4 in such a manner that respective sound sources are aligned in a fore-and-aft direction, the radiated sound from the tweeter 5 does not hit the pair of enhanced walls 10. Accordingly, the radiated sound from the tweeter 5 is not reflected but is radiated forward into a listening space L (see FIGS. 2 to 4). Also, the sounds radiated from the speakers 4, 5 neighboring each other are mixed inside the pair of enhanced walls 10 and radiated forward into the listening space L. Therefore, the radiated sounds from the speakers 4, 5 become harmonized and realistic. In addition, the pair of enhanced walls 10 disposed vertically along the front face of the baffle board 2 makes a front appearance of the speaker device 1 balanced.

### Second Embodiment

FIG. 8 is a perspective view of a speaker device 1b according to a second embodiment. The speaker device 1b is configured such that apart of the speaker device 1 of the first embodiment is modified. Description of the common components will be omitted.

The speaker device 1b of this embodiment each includes three types of speaker, a woofer 3, a squawker 4, and a tweeter 5. The speaker device 1b constitutes a three-way speaker system by itself. That is, in the speaker device 1b of this embodiment, the squawker 4 is a reference speaker according to the present invention. The squawker 4 and the tweeter 5 incorporated in the speaker device 1b are same to those in the first embodiment. The woofer 3 is a cone-type speaker in 30 cm diameter.

The speaker device 1b includes a baffle board 2a, which is slightly longer than the baffle board in the first embodiment. The squawker 4 is positioned generally at a center on the backside face of the baffle board 2a, the tweeter 5 is positioned above the squawker 4, and the woofer 3 is positioned below the squawker 4. Each of the speakers 3, 4, 5 is arranged in line in such a manner that respective sound sources are aligned in a fore-and-aft direction as shown in FIGS. 8 and 9. The center of the squawker 4 is positioned approximately 50 cm above the lower end of the speaker device 1b. The distance from the upper end of the speaker device 1b to the center of the squawker 4 is same to that of the first embodiment.

The backside of the squawker 4 is surrounded by a closed-type cabinet 11 in the same shape as the first embodiment as shown in FIG. 9. Further, the speaker device 1b has on its back a closed-type cabinet 15 for shutting off the radiated sound from the woofer 3 so that the closed-type cabinet 15 surrounds the whole backside of the baffle board 2a.

In the front side of the baffle board 2a, a pair of enhanced walls 10a vertically extending along a front face of the baffle board 2a is disposed in such a manner that the pair of enhanced walls 10a covers left and right parts of the radiating face of the squawker 4. A sectional shape of the pair of enhanced walls 10a is same as the pair of enhanced walls 10 in the first embodiment. However, the longitudinal dimension of the pair of enhanced walls 10a is slightly longer to be aligned with the baffle board 2a. Further, a pair of enhanced walls for high frequency range 12 is disposed on the front face of the baffle board 2a at an attachment part of the tweeter 5, which is same as in the first embodiment.

Here, as shown in FIGS. 11 and 12, the pair of enhanced walls 10a is jointed with the baffle board 2a at the location in which the pair of enhanced walls 10a extends along outer sides of the radiating faces of the squawker 4 and the tweeter 5. Accordingly, all the radiated sounds from the squawker 4 and the tweeter 5 are radiated forward through the inside of the pair of enhanced walls 10a into the listening space L.

Meanwhile, as shown in FIG. 10, the pair of enhanced walls 10a passes through left and right positions closer to the center of the radiating face of the woofer 3, which is different from the situation between the pair of enhanced walls 10a and the left and right side parts of the radiating face of the squawker 4. Accordingly, the pair of enhanced walls 10a is not jointed with the baffle board 2a at these positions. The pair of enhanced walls 10a forms outer vacancies 28, 28 defined between outer wall surfaces of the pair of enhanced walls 10a and the front face of the baffle board 2a, and forms enhancement suppression gaps 16, 16 through which the radiated sound from the woofer 3 is radiated into the listening space L.

In this embodiment, the radiated sound of the woofer 3 is not only radiated into the inside of the pair of enhanced walls 10a but also passed through the outer vacancies 28 via the enhancement suppression gaps 16 to be radiated into the listening space L. Accordingly, an acoustic load of the pair of enhanced walls 10a applied on the radiated sound of the woofer 3 is suppressed. Thereby, the sound pressure characteristics of the woofer 3 become flat.

### Fourth Comparative Example

Removing the pair of enhanced walls 10a and the pair of enhanced walls for high frequency range 12 from the speaker device 1b of the second embodiment makes a speaker device (not shown) of a fourth comparative example.

[Test 3]

The frequency characteristics were checked for each of the speaker devices of the second embodiment and the fourth comparative example, in which the crossover frequency between the woofer 3 and the squawker 4 is set to 400 Hz and the crossover frequency between the squawker 4 and the tweeter 5 is set to 1,500 Hz. The measuring microphone was set in the same place as in Tests 1 and 2. Test results are shown in FIG. 13.

As clearly shown in FIG. 13, there is little difference in sound pressure levels between the second embodiment and the fourth comparative example in a range equal to or less than 300 Hz. In a range equal to or more than 300 Hz, the sound pressure level of the second embodiment outweighs that of the fourth comparative example. Although the radiated sounds from the squawker 4 and the tweeter 5 are enhanced by the pairs of the enhanced walls 10a, 12, the radiated sound from the woofer 3 is hardly enhanced.

As described above, in the speaker device 1b of this embodiment, the radiated sounds from the squawker 4 (reference speaker) and the tweeter 5 have similar acoustics to the radiated sound from the horn-type speaker. Further, the pair of enhanced walls 10a is arranged to form inner wall surfaces in the left and the right sides of the squawker 4 (reference speaker) extending along a radiating direction of all the speakers. Therefore, if the woofer 3 and the tweeter 5 are respectively arranged closely above and below the squawker 4 and respective sound sources are aligned in a fore-and-aft direction, respective radiated sounds neither hit the pair of enhanced walls 10a nor reflect as in the horn-type speaker. Also, in this embodiment, an appropriate amount of the radiated sound of the woofer 3 passes along the outside of the pair of enhanced walls 10a via the enhancement suppression gaps 16 and the outer vacancies 28 to be radiated into the listening space L. Thereby, the sound pressure characteristics of the woofer 3 can be made flat.

### Third Embodiment

FIG. 14 is a perspective view of a speaker device 1c including a horn-type tweeter according to a third embodiment. The speaker device 1c is only different from the speaker device 1b of the second embodiment in term of the configuration around the attachment part of the tweeter. Thus, common components will be denoted in the same numerals and their description will be omitted.

In the speaker device 1c of this embodiment, a horn 17 instead of the pair of enhanced walls for high frequency range 12 is disposed on the front face of the baffle board 2a at the attachment part of the tweeter 5. The horn 17 is designed in a shape to enhance the radiated sound from the tweeter 5. The tweeter 5 is disposed behind a throat 9c of the horn 17. The tweeter 5 is a same one as in the first embodiment.

Left and right side plates 17b, 17c of the horn 17 are smoothly jointed with the inner wall surfaces of the pair of enhanced walls 10a. Accordingly, the radiated sound from the tweeter 5 neither hits nor reflects from the inner wall surfaces of the pair of enhanced walls 10a at the left and the right edges of the horn 17. Meanwhile, a lower bottom surface of a side plate 17d which constitutes a lower part of the horn 17 is formed to be slanted along a radiating direction from the side edge of the radiating face of the squawker 4 so that the radiated sound from the squawker 4 neither hits nor reflects from it.

A horizontal divider plate 21 having a triangle section is disposed on the front face of the baffle board 2a between the woofer 3 and the squawker 4. The front end of the horizontal divider plate 21 is positioned in the rear of the front end of the horn 17.

### Fourth Embodiment

FIG. 15 is a perspective view of a speaker device 1d according to a fourth embodiment. The speaker device 1d is only different from the speaker device 1b of the second embodiment in terms of the configuration around the attachment part of the tweeter. Thus, common components will be denoted in the same numerals and their description will be omitted.

As shown in FIGS. 15 to 17, the speaker device 1d of this embodiment includes a horn-type tweeter, in which a horn 14 for tweeter is disposed in front of the tweeter 5 in such a manner that its inner wall opens toward forward in a vertical direction and is formed in a shape to enhance the radiated sound from the tweeter 5 and to have wide directivity in a horizontal direction. Here, in the both side vicinities of an opening 26 of the horn 14, directivity widening gaps 18, 18 are formed to pass the radiated sound from the tweeter 5 outside the pair of enhanced walls 10a. By the use of this, the radiated sound from the tweeter 5 is radiated also through the outside of the pair of enhanced walls 10a into the listening space L. Thereby, the wide directivity in a horizontal direction can be secured for the reproduced sound of the tweeter 5.

As shown in FIG. 17, as the radiated sound from tweeter 5 leaks to the left and the right directivity widening gaps 18, the left and the right pair of enhanced walls 10a hardly enhances the radiated sound from the tweeter 5 and merely functions as a divider plate. However, as shown in FIG. 16, the radiated sound from tweeter 5 is enhanced because an acoustic load is vertically applied by the horn 14. At end edges of the pair of enhanced walls 10a that form the directivity widening gaps 18, fins 22 are disposed to be directed at an acute angle against the radiating face of the tweeter 5 so that the radiated sound from the tweeter 5 does not hit the end edges and does not reflect to be distorted. Also, a lower side face of the horn 14 bordering the radiating face of the squawker 4 is smoothly slanted upward toward forward. Therefore, the radiated sound from the squawker 4 does not hit the lower face to be reflected.

### Fifth Embodiment

FIG. 18 is a perspective view of a speaker device 1e according to a fifth embodiment. The speaker device 1e of this embodiment includes two woofers 3a, 3a, two squawkers 4, 4, and a single tweeter 5. The speaker device 1e constitutes a three-way speaker system by itself. That is, in this embodiment, the squawkers 4, 4 are reference speakers according to the present invention. Accordingly, the speaker device 1e is provided with two reference speakers. Meanwhile, the woofer 3a is smaller in diameter than the woofer 3 in the second embodiment, while the squawker 4 and the tweeter 5 are same as those in the second embodiment.

The speaker device 1e has a vertically long baffle board 2b. On the backside surface of the baffle board 2b, each speaker 3a, 4, 5 is arranged in line so that respective sound sources of the speakers are aligned in a fore-and-aft direction. In this embodiment, the woofers 3a and the squawkers 4 are arranged virtually coaxial respectively below and above the tweeter 5. That is, the tweeter 5 is arranged in the center of the baffle board 2b, the squawkers 4 are symmetrically arranged above and below the tweeter 5 and the woofers 3a are symmetrically arranged in the both ends of the baffle board 2b.

A pair of enhanced walls 10b according to this embodiment, which covers left and right parts of the radiating face of each of the squawkers 4, vertically extends along a front face of the baffle board 2b. As shown FIG. 18, the pair of enhanced walls 10b sufficiently extends up and down through the radiating faces of the squawkers 4. Therefore, the radiated sounds of the squawkers 4 are enhanced inside the pair of enhanced walls 10b and mixed with the radiated sounds from each of speakers that reproduce other ranges to be radiated into a listening space. Further, a pair of enhanced walls for high frequency range 12 is disposed on the front face of the baffle board 2 at an attachment part of the tweeter 5 as in the second embodiment and enhancement suppression gaps 16, 16 are formed in the both sides of the radiating faces of each woofer 3a.

The upper and the lower ends of the pair of enhanced walls 10b are respectively joined with a top board 20a and a bottom board 20b of a cabinet 15a so that the pair of enhanced walls 10b is fixed to be stable. Although the pair of enhanced walls 10b is fixed to the cabinet 15a as described above, the upper and the lower ends of the inside space of the pair of enhanced walls 10b are open. Accordingly, there are no places at which the radiated sound from each of speakers 3a, 4, 5 hits and reflects. Meanwhile, it is possible that the radiated sounds from the woofer 3a passing through the enhancement suppression gaps 16 hit parts of the top board 20a and the bottom board 20b to be reflected. However, since a reflected part is small, there is very small possibility that the radiated sound from the woofer 3, which is low frequency, is distorted.

### Sixth Embodiment

FIG. 19 is a perspective view of a speaker device 1f according to a sixth embodiment. The speaker device 1f has a difference of the configuration around the attachment part of the tweeter from the speaker device 1e of the fifth embodiment. Thus, common components will be denoted in the same numerals and their description will be omitted.

This embodiment is characterized in that a horn-type tweeter is adopted. That is, the speaker device 1f includes a tweeter 5 having a horn 19 in the center of the baffle board 2b. Squawkers 4,4 and woofers 3, 3 are arranged virtually coaxial respectively above and below the tweeter 5. The woofer 3 is same in diameter as in the second embodiment.

Here, the horn 19 has a rectangular opening sized 11 cm (height) by 17 cm (width) and is disposed on the front face of the baffle board 2b in such a manner that the throat of the horn is aligned with the radiating face of the tweeter 5. Left and right front-ends of inner walls of the horn 19 are smoothly jointed with inner walls of a pair of enhanced walls 10b. Thereby, the radiated sound from the tweeter 5 does not hit inner wall surfaces of the pair of enhanced walls 10b and does not reflect. In addition, on the upper and the lower outer wall surfaces of the horn 19, surfaces are formed from the side edges of the squawkers 4 in a radiating direction of the sound wave. Therefore, the radiated sounds from each of squawkers 4 do not hit the horn 19 and do not reflect.

Here, in this embodiment, the vertical dimension (the vertical dimension of the horn opening plus thickness of the board) of an opening 26a of the horn 19 is 16 cm. The opening 26a of the horn 19 is positioned 12 cm behind the front end of the pair of enhanced walls 10b. Thus, the radiated sounds from the upper and the lower squawkers 4, 4 can be mixed in the forward space of the horn 19 by recessing the horn 19. In other words, if the horn 19 is excessively protruded forward, an inner space of the pair of enhanced walls 10b is vertically divided and the sound pressure enhancement effect of the pair of enhanced walls 10b is reduced by half around the cut-off frequency. In contrast, in this embodiment, the sound pressure enhancement effect around the cut-off frequency by the pair of enhanced walls 10b is not reduced.

In particular, if the distance (“Y” on FIG. 20) from the front end of the pair of enhanced walls 10b to the opening 26a of the horn 19 is more than one half of the vertical dimension (“XX” in FIG. 20) of the horn 19, reduction of the sound pressure enhancement effect described above can be improved. That is, in a case that the vertical dimension of the horn is 16 cm as in this embodiment, the opening of the horn is merely required to be recessed no less than 8 cm. However, it is preferable that the opening of the horn is recessed no less than 11 cm to avoid adverse effect as in this embodiment.

Meanwhile, in this embodiment, the radiated sound from the woofer 3 may hit the outer wall of the horn 19 and reflect. However, in a case that the dimension of the horn 19 protruding forward is short as in this embodiment, its influence on the low-frequency radiated sound from the woofer 3 is thought to be small.

### Seventh Embodiment

FIG. 21 is a perspective view of a speaker device 1g according to a seventh embodiment. The speaker device 1g includes four types of speaker, a woofer 3b for reproducing a low frequency range, a mid-bass 6 for reproducing a medium-low frequency range, a squawker 4a for reproducing a medium-high frequency range, and a tweeter 5 for reproducing a high frequency range. The speaker device 1g alone constitutes a four-way speaker system. That is, in the speaker device 1g of this embodiment, the mid-bass 6 is a reference speaker according to the present invention.

In this embodiment, a cone-type speaker in 38 cm diameter, a cone-type speaker in 25 cm diameter, and a cone-type speaker in 8 cm diameter are respectively adopted for the woofer 3b, for the mid-bass 6, and for the squawker 4a. Also, a dome-type speaker in 28 mm diameter is adopted for the tweeter 5 as in the first embodiment. The mid-bass 6 as the reference speaker is arranged in the center of a vertically-long rectangular baffle board 2c. The squawker 4a is arranged above the mid-bass 6 and the tweeter 5 is arranged above the squawker 4a, both being disposed from the backside of the baffle board 2c. The woofer 3b is arranged below the mid-bass 6 and attached to the front-side of the baffle board 2c. All speakers are arranged in line so that respective sound sources for speakers 3b, 6, 4a, 5 are generally aligned in a fore-and-aft direction. The cross-over frequencies between speakers 3b, 6, 4a, 5 are 250 Hz, 700 Hz, and 2,500 Hz.

A closed-type cabinet 15b is disposed on the backside face of the baffle board 2c. Inside the closed-type cabinet 15b, the squawker 4a and the mid-bass 6 are surrounded by another closed-type cabinet (not shown) from their behind.

A pair of enhanced walls 10c according to this embodiment, whose front end is 36 cm distant from its base end, passes by the both sides of the radiating face of the mid-bass 6 while covering left and right parts of the radiating face of the mid-bass 6 and vertically extends along the baffle board 2c. A pair of enhanced walls for medium-high frequency range 23 for enhancing the radiated sound from the squawker 4a is disposed on the front face of the baffle board 2c at an attachment part of the squawker 4a. The pair of enhanced walls for medium-high frequency range 23 extends from both sides of the upper end of the mid-bass 6 to the upper end of the baffle board 2c. The upper, the lower and the front ends of the inner wall surfaces of the pair of enhanced walls for medium-high frequency range 23 are smoothly jointed with the inner wall surfaces of the pair of enhanced walls 10c. Therefore, the radiated sounds from the woofer 3b, the mid-bass 6, the squawker 4a, and the tweeter 5 do not hit the pair of enhanced walls for medium-high frequency range 23 and do not reflect.

Further, a pair of enhanced walls for high frequency range 12b for enhancing the radiated sound from the tweeter 5 is disposed on the front face of the baffle board 2c at an attachment part of the tweeter 5. The pair of enhanced walls for high frequency range 12b is jointed both with the baffle board 2c and the pair of enhanced walls for medium-high frequency range 23. The upper, the lower and the front ends of the inner wall surfaces of the pair of enhanced walls for high frequency range 12b are smoothly jointed with the inner wall surfaces of the pair of enhanced walls for medium-high frequency range 23 so that the radiated sounds from the squawker 4a and the tweeter 5 as well as from the woofer 3b and the mid-bass 6 smoothly proceed along these ends. Therefore, the radiated sounds from the woofer 3b, the mid-bass 6, the squawker 4a, and the tweeter 5 do not hit the ends of the pair of enhanced walls for high frequency range 12b and do not reflect. Both side parts of the radiating face of the woofer 3b widely extend outside the pair of the enhanced walls 10c. The extended part suitably divides a space between the inside and the outside with respect to the pair of enhanced walls 10c and widely forms an enhancement suppression gap 16. Therefore, unlike the second embodiment, the pair of the enhanced walls 10c has no recessed gap on the radiating face of the woofer.

### Eighth Embodiment

FIG. 22 is a perspective view of a speaker device 1h according to an eighth embodiment. The speaker device 1h has an only difference in the configuration of the pair of enhanced walls from the speaker device 1g of the seventh embodiment. Thus, common components will be denoted in the same numerals and their description will be omitted.

As shown in FIGS. 22 and 23, the speaker device 1h is not provided with a pair of enhanced walls for high frequency range or a pair of enhanced walls for medium-high frequency range. Instead, a pair of enhanced walls 10d, whose front-end is 36 cm distant from its base end at a height of the mid-bass as in the seventh embodiment, is provided, in which its portion higher than the squawker 4a is deformed.

In particular, rear ends of the pair of enhanced walls 10d are curved inward so that they pass by the side edges of the radiating faces of the squawker 4a and the tweeter 5. The pair of enhanced walls 10d curves outside from the rear end to a position 15 cm forward of the baffle board 2c so that an opening degree thereof gradually increases. The pair of enhanced walls 10d laterally forms an angle of 90 degrees at the position 15 cm forward of the baffle board 2c and further extends straight to the front end without varying its opening degree. The front end of the pair of enhanced walls 10d is located 30 cm forward of the baffle board 2c at a height of the squawker 4a and located 15 cm forward of the baffle board 2c at a height of the tweeter 5. This is because the radiated sounds from the mid-bass 6, squawker 4a and the tweeter 5 are not so enhanced even if the pair of enhanced walls 10d is extended forward more. Furthermore, a higher part of the frequency range of the radiated sound from the tweeter 5 is depressed by the extended part of the pair of enhanced walls 10d.

### Ninth Embodiment

FIG. 24 is a perspective view of a speaker device 1i according to a ninth embodiment. A baffle board 2d according to this embodiment has a step in a fore-and-aft direction. A pair of enhanced walls 10e is disposed on such the baffle board 2d.

In particular, the baffle board 2d of the speaker device 1i includes a lower board 25a disposed on the front side, an upper board 25b disposed on the rear side, and a slanted intermediate board 25c for connecting the lower board 25a and the upper board 25b. The step about 20 cm is formed in a fore-and-aft direction between the lower board 25a and the upper board 25b. The speaker device 1i has three speakers, a woofer 3 disposed on the back of the lower board 25a, a squawker 4 (reference speaker) and a tweeter 5 disposed on the back of the upper board 25b. Here, the squawker 4 is disposed on the upper board 25b in such a manner that its sound source is positioned 20 cm behind the sound source of the woofer 3. Further, the tweeter 5 is disposed on the upper board 25b via a horn 24, whose sound source is positioned 5 cm further behind the sound source of the squawker 4. Such a configuration in a fore-and-aft direction of the sound sources of the speakers 3, 4, 5 is called “Linear Phase,” and intended to compensate phase shifts between each speaker at the cross-over frequencies and phase shifts by the dividing networks with intervals in a fore-and-aft direction between the sound sources of the speakers.

The pair of enhanced walls 10e according to this embodiment is formed in generally similar shape to the pair of enhanced walls 1a in the second embodiment and disposed to cover left and right parts of the radiating face of the squawker 4 and pass by the both sides thereof. However, the lower parts of the rear ends of the pair of enhanced walls 1e are cut off corresponding to the stepped shape of the baffle board 2d. Here, in this embodiment, the pair of enhanced walls 10e is disposed outside the radiating face of the woofer 3. Accordingly, an enhancement suppression gap 16a is formed for passing the radiated sound from the woofer 3 outside the pair of enhanced walls 10e in a slit shape at a joint of the pair of enhanced walls 10e and the baffle board 2d (lower board 25a). In addition, a pair of enhanced walls for high frequency range 12b is disposed on the front face of the baffle board 2d at an attachment part of the tweeter 5.

### Tenth Embodiment

FIG. 25 is a perspective view of a speaker device 1j according to a tenth embodiment. The speaker device 1j includes four squawkers 4, 4 and a single tweeter 5. Combination of the speaker device 1j and another speaker device 1k having two woofers 3b, 3b constitute a three-way speaker system which reproduces down to a low-frequency range and has an acoustic load including a low-frequency component. In this embodiment, the squawker 4 is a reference speaker according to the invention.

In the speaker device 1j of this embodiment, the tweeter 5 is disposed in the center of the baffle board 2e and the two squawkers 4 are respectively disposed above and below the tweeter 5. The tweeter 5 is provided with a horn 19a formed generally similar to the one in the sixth embodiment. On the other hand, the squawker 4 is the same one in the first embodiment. The squawkers 4 are arranged virtually coaxial around the tweeter 5. In this embodiment, a pair of enhanced walls 10f is vertically extended so that the minimum distance through which the radiated sound from the squawker 4 (reference speaker) arranged in line on the baffle board 2e reaches the upper and the lower ends of the pair of enhanced walls 10f is longer than the minimum distance through which the radiated sound reaches the front end of the pair of enhanced walls 10f.

Boards 27, 27 are disposed on and under the baffle board 2e to be slanted in such a manner that central side edges of the boards 27, 27 are respectively jointed with the baffle board 2e, the upper and the lower ends of the boards 27, 27 are respectively aligned with the upper and the lower ends of the pair of enhanced walls 10f, and the upper and the lower ends of the boards 27, 27 are moved forward in order to enhance the radiated sound from the squawker 4 further effectively. However, if the radiated sounds from the tweeter 5 and the lower squawkers 4 hit the upper board 27 or the radiated sounds from the tweeter 5 and the upper squawkers 4 hit the lower board 27 and the radiated sounds reflect to be distorted, such situations spoil the effect of the present invention. Therefore, it is preferable that the upper and the lower ends of the boards 27, 27 are positioned behind the front end of the horn 19 for tweeter so that the radiated sounds do not hit the boards 27 and do not reflect. Further, the opening of the horn 19a disposed in the center of the baffle board 2e is positioned behind the front end of the pair of enhanced walls 10f by a distance of more than the vertical dimension of the opening of the horn 19a. Therefore, the sound pressure enhancement effect of the pair of enhanced walls 10f is not reduced around the cut-off frequency due to the horn 19a.

Thus, division into the speaker device 1j and the other speaker device 1k having the two woofers 3b makes it possible that the height of the central tweeter 5 of the speaker device 1j is set to the front of the listener and the arrival time of the radiated sound from each of speakers arranged virtually coaxial on the speaker device 1j is aligned. Further, weight reduction provides many advantages such that moving and setting become easy and unnecessary resonance of the cabinet can be suppressed. The speaker device 1k, which reproduces only a substantially low frequency range as in this embodiment, gives no artificiality even though it is a little separated from the speaker device 1j for reproducing a high frequency range. Also, the arrival time of the radiated sound from the speaker device 1k can be aligned with that from the speaker device 1j.

Though embodiments of the invention are described as above, the speaker device according to the present invention is not limited to these embodiments. Various modifications may be practiced in response to types and characteristics of each speaker without departing from the spirit of the invention. The pair of enhanced walls of the aforementioned embodiment is symmetrically arranged in the center of baffle board. However, for example, the pair of enhanced walls may be arranged to be deviated from the center of the baffle board or may be configured asymmetrically. Further, the central part in a fore-and-aft direction may be thickened and its inner wall surface and its outerwall surface may be formed symmetrical. Furthermore, the pair of enhanced walls may be modified in the position or in the shape in response to types and characteristics of the reference speaker so that the speaker may sufficiently fulfill its potential. In addition, a separate configuration of a super-tweeter or a super-woofer may be added to the speaker device of the present invention to expand a reproducing range. The speaker device provided with the pair of enhanced walls also has another advantage in which a distinctive speaker system may be produced with various concepts and designs in comparison with a general speaker device.

### BRIEF DESCRIPTION OF DRAWINGS

FIG. 1 is a perspective view of a speaker device 1 according to a first embodiment.

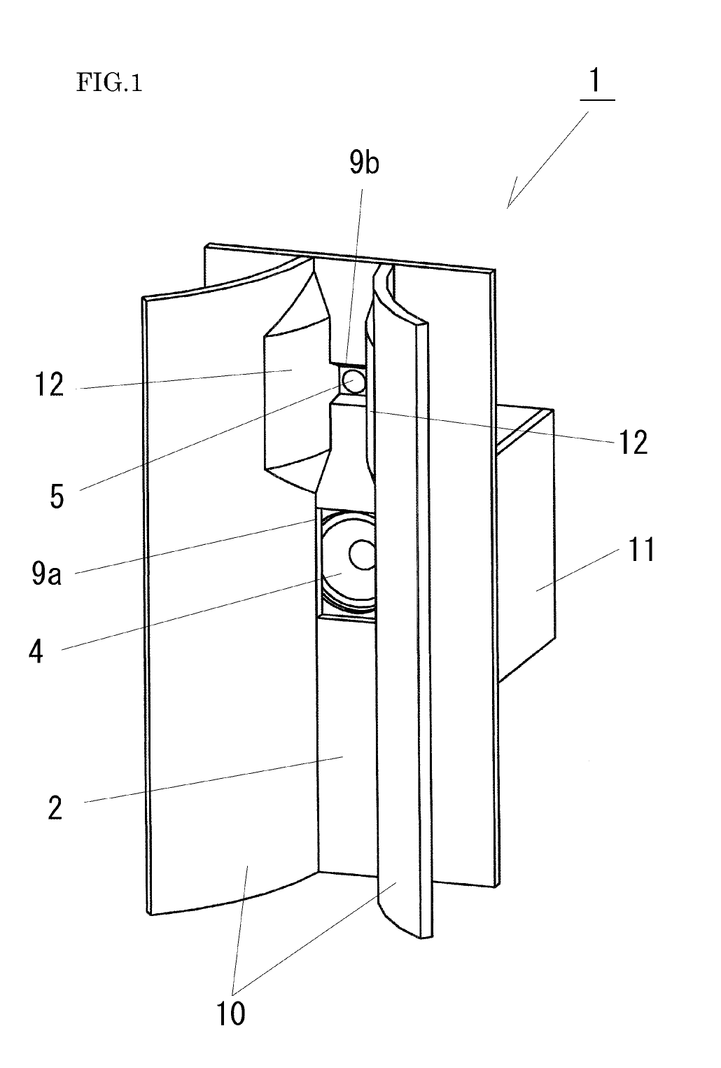

FIG. 2 is a sectional side view of the speaker device 1.

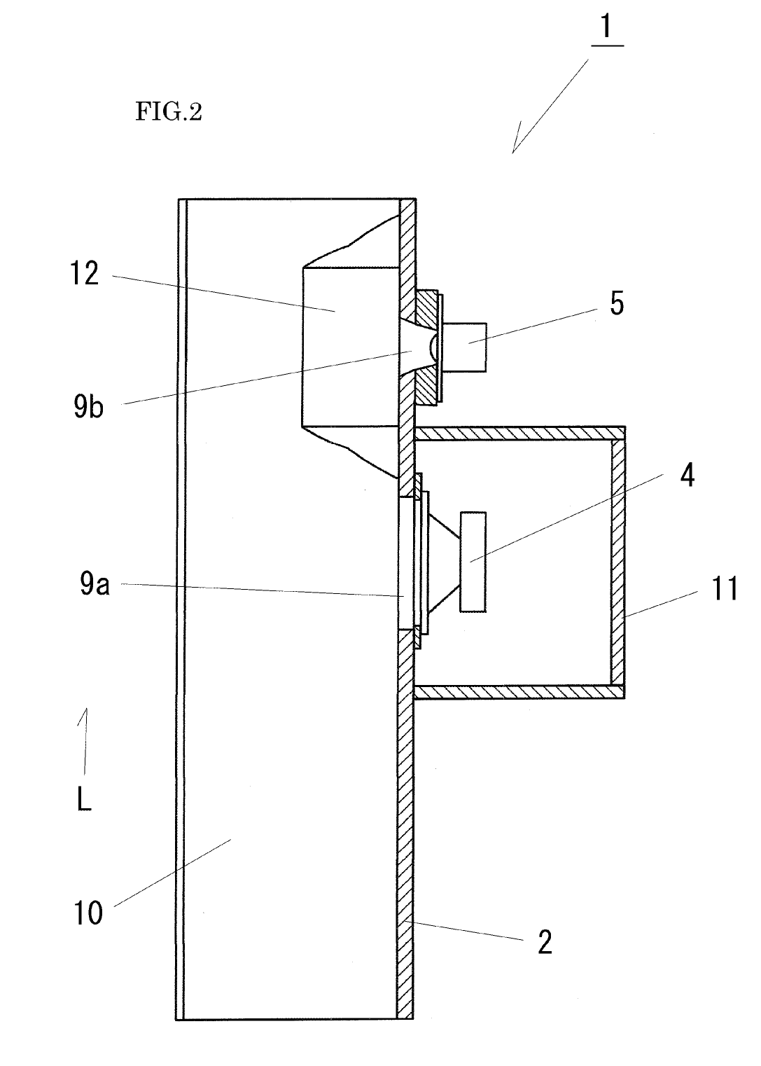

FIG. 3 is a laterally sectional view of the speaker device 1 at a height of a squawker 4.

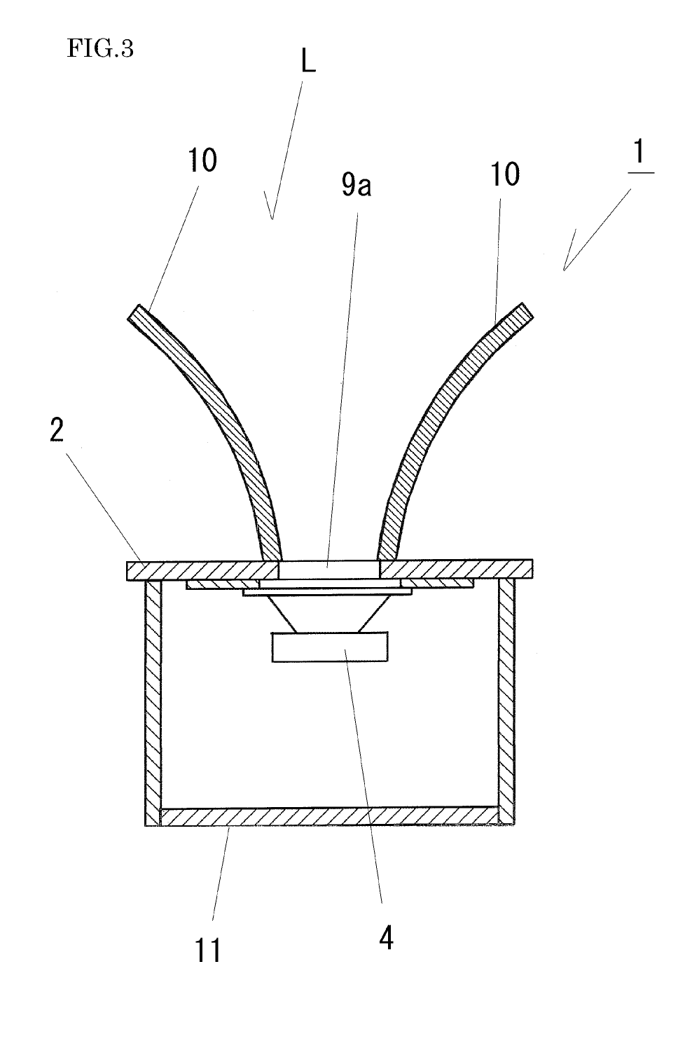

FIG. 4 is a laterally sectional view of the speaker device 1 at a height of a tweeter 5.

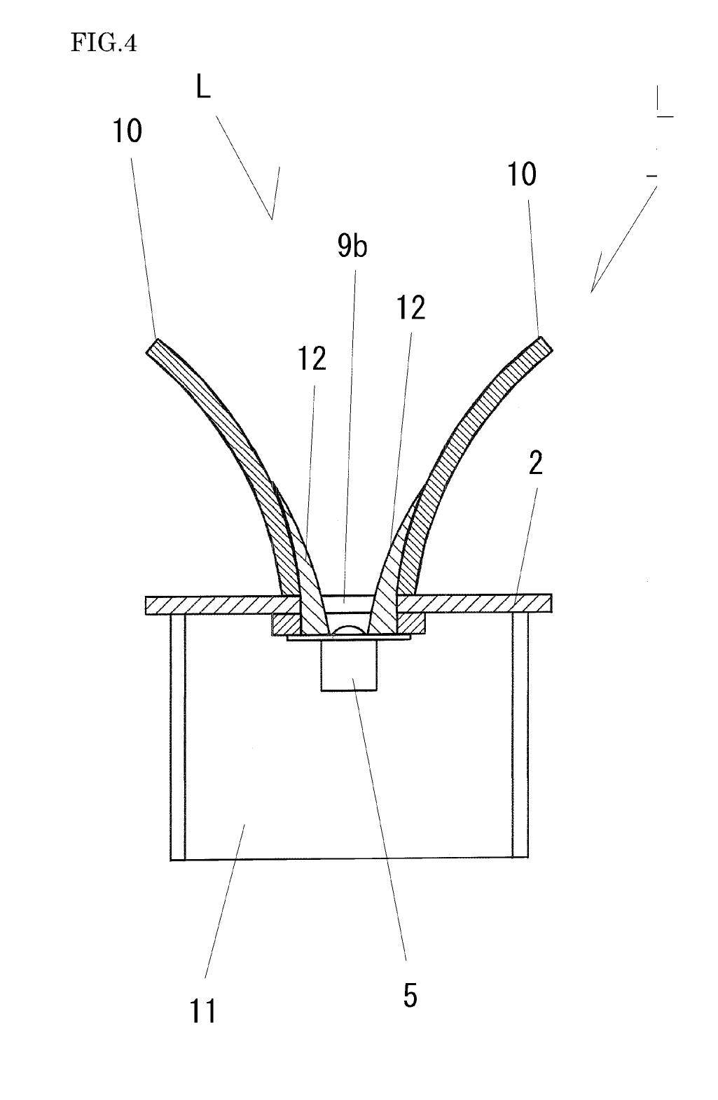

FIG. 5 is a perspective view of a speaker device 1a of a first comparative example.

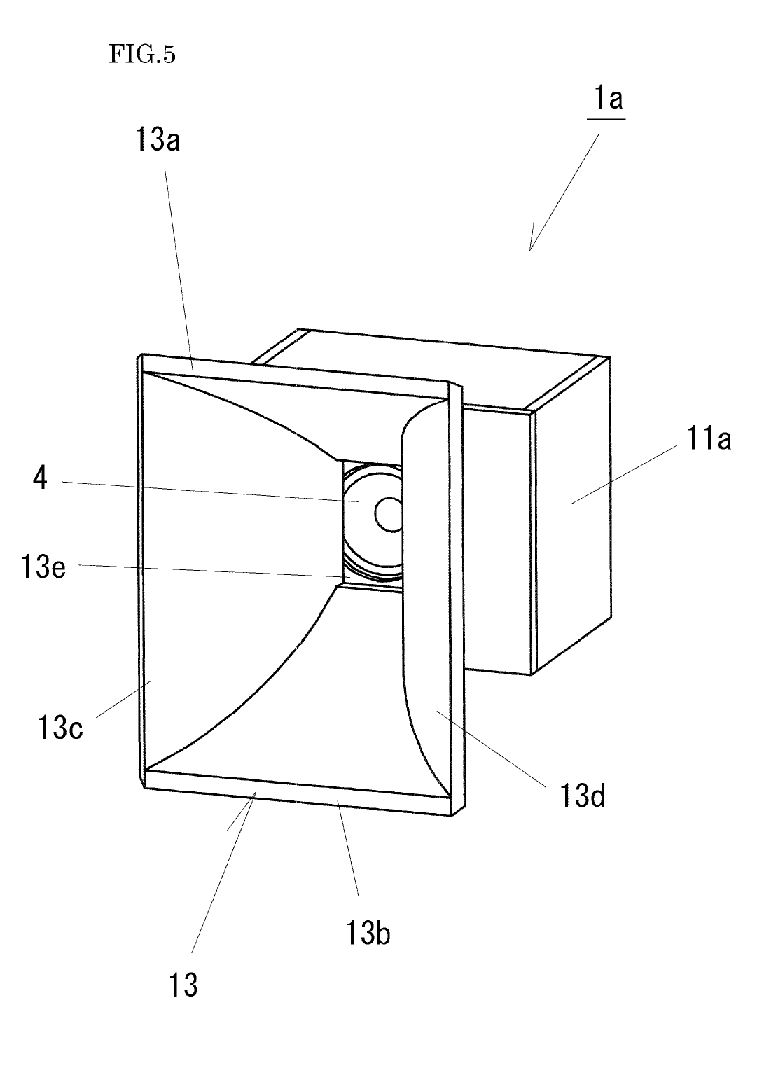

FIG. 6 is a graph of the frequency characteristics of the squawker 4 in the speaker devices of the first embodiment, the first comparative example, and a second comparative example.

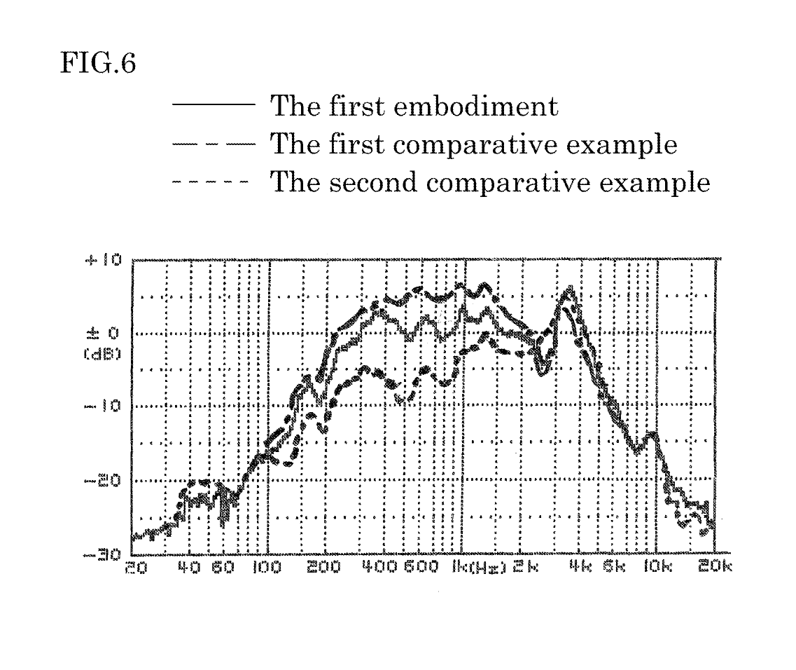

FIG. 7 is a graph of the frequency characteristics of the speaker devices in the first embodiment and a third comparative example.

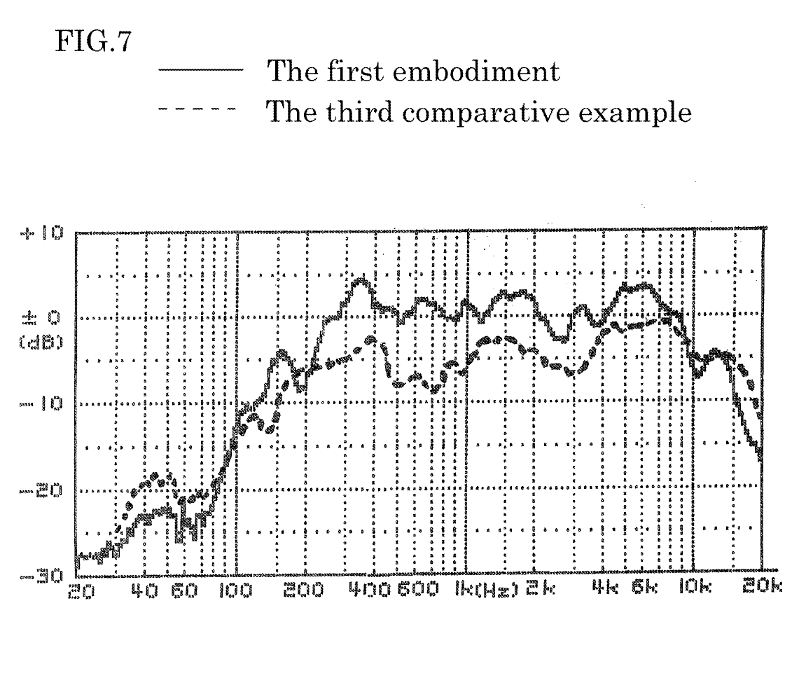

FIG. 8 is a perspective view of a speaker device 1b according to a second embodiment.

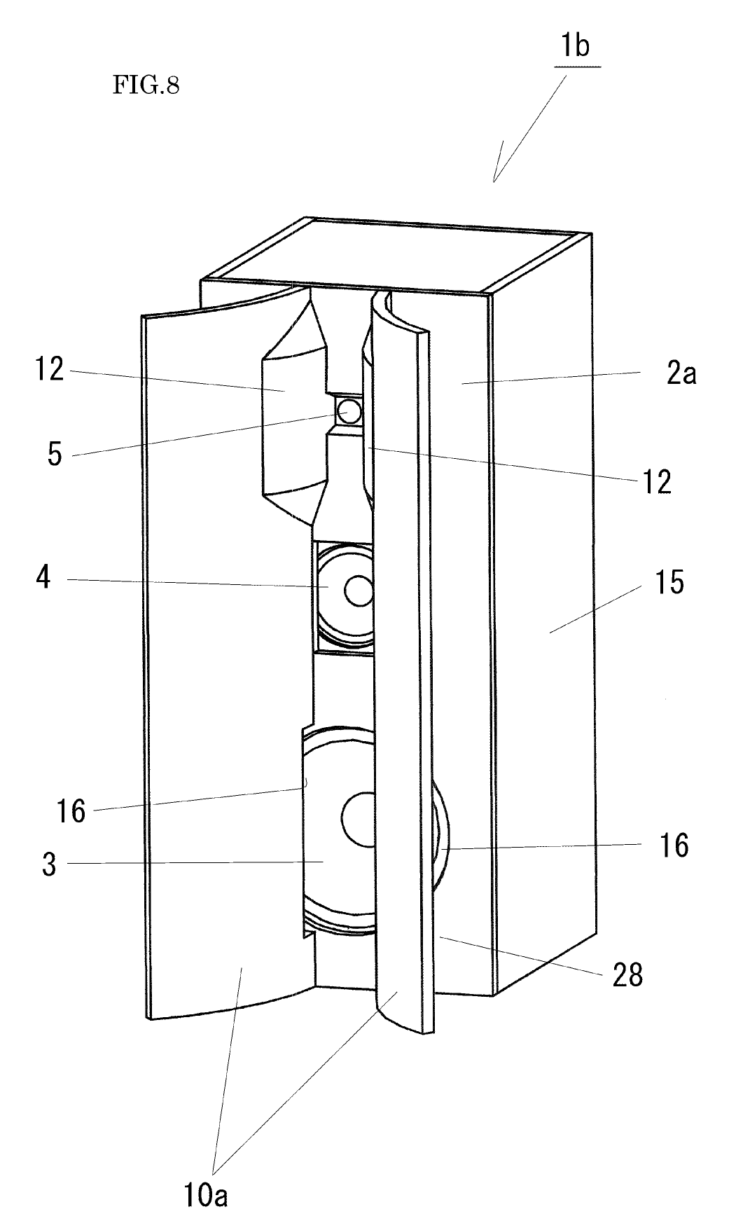

FIG. 9 is a sectional side view of the speaker device 1b.

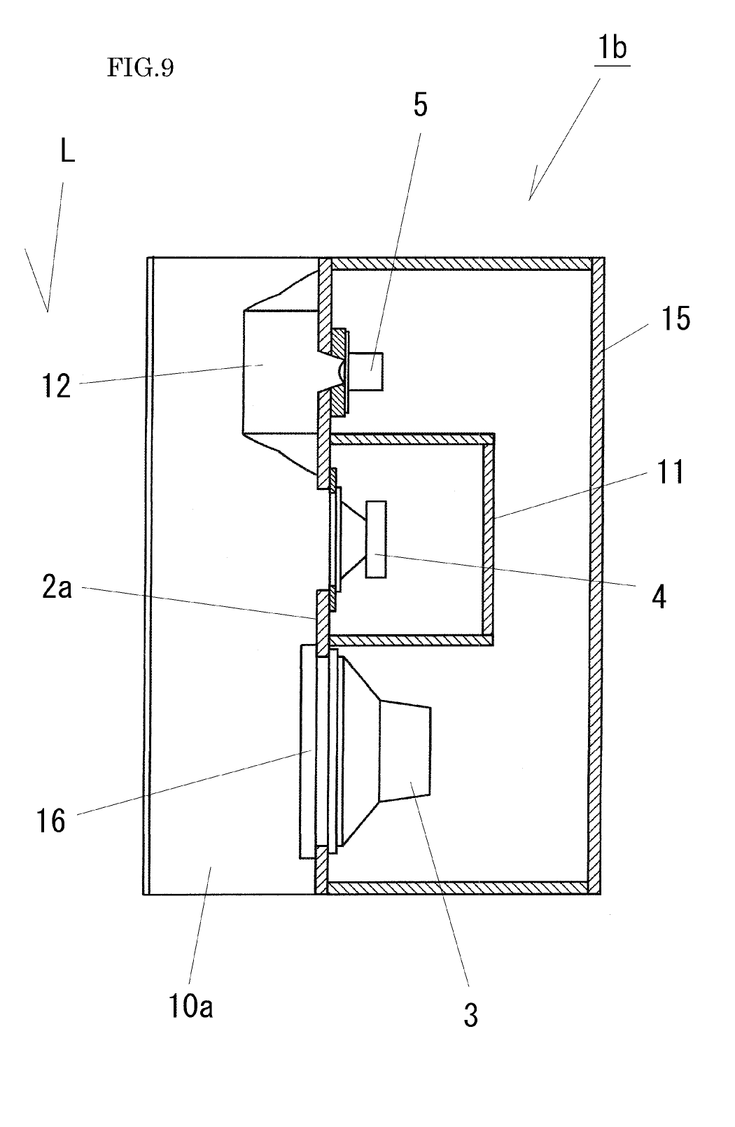

FIG. 10 is a laterally sectional view of the speaker device 1b at a height of a woofer 3.

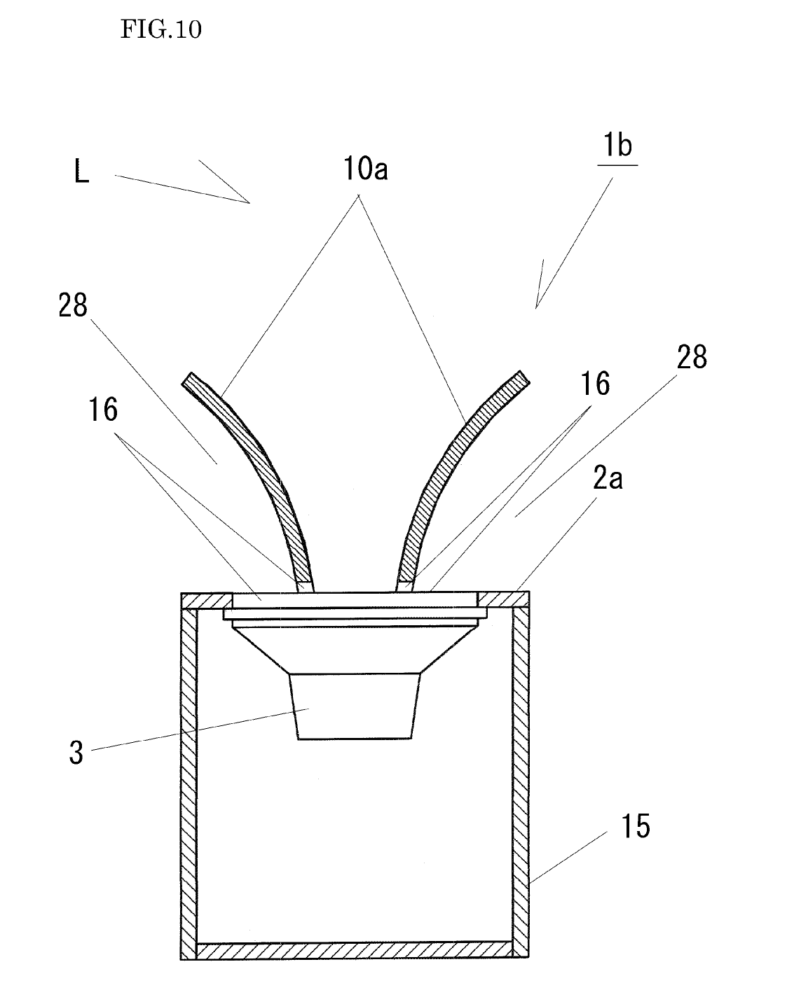

FIG. 11 is a laterally sectional view of the speaker device 1b at a height of a squawker 4.

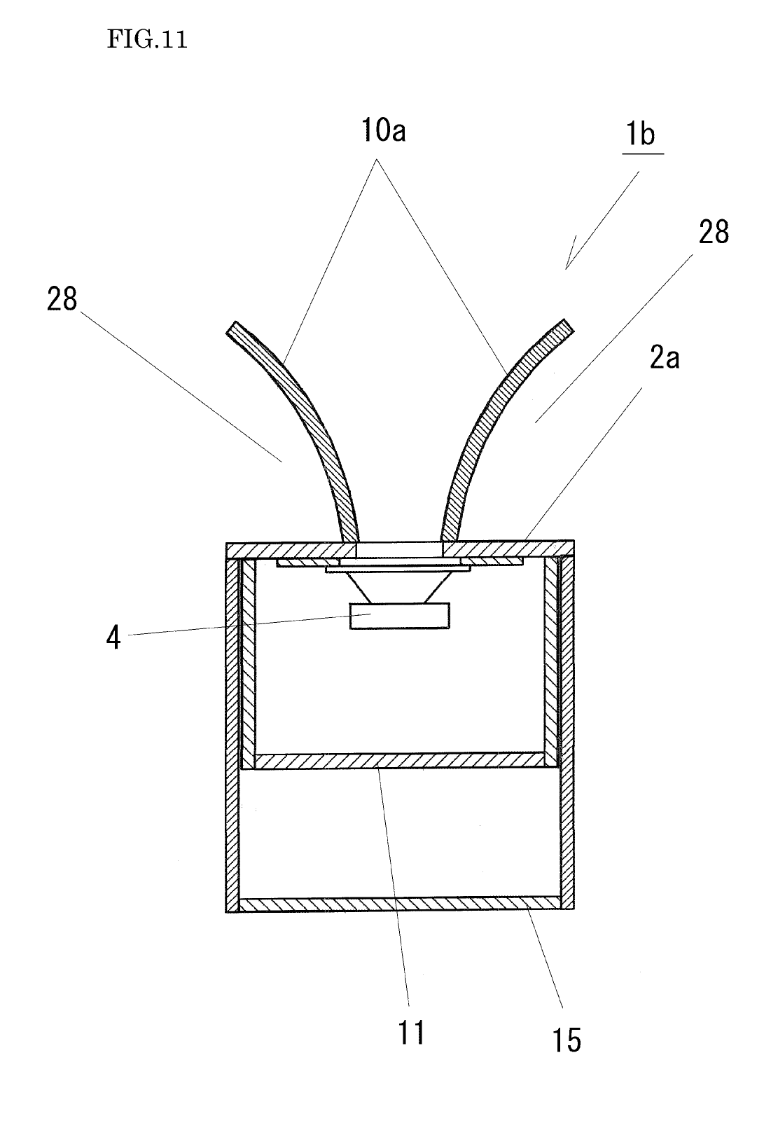

FIG. 12 is a laterally sectional view of the speaker device 1b at a height of a tweeter 5.

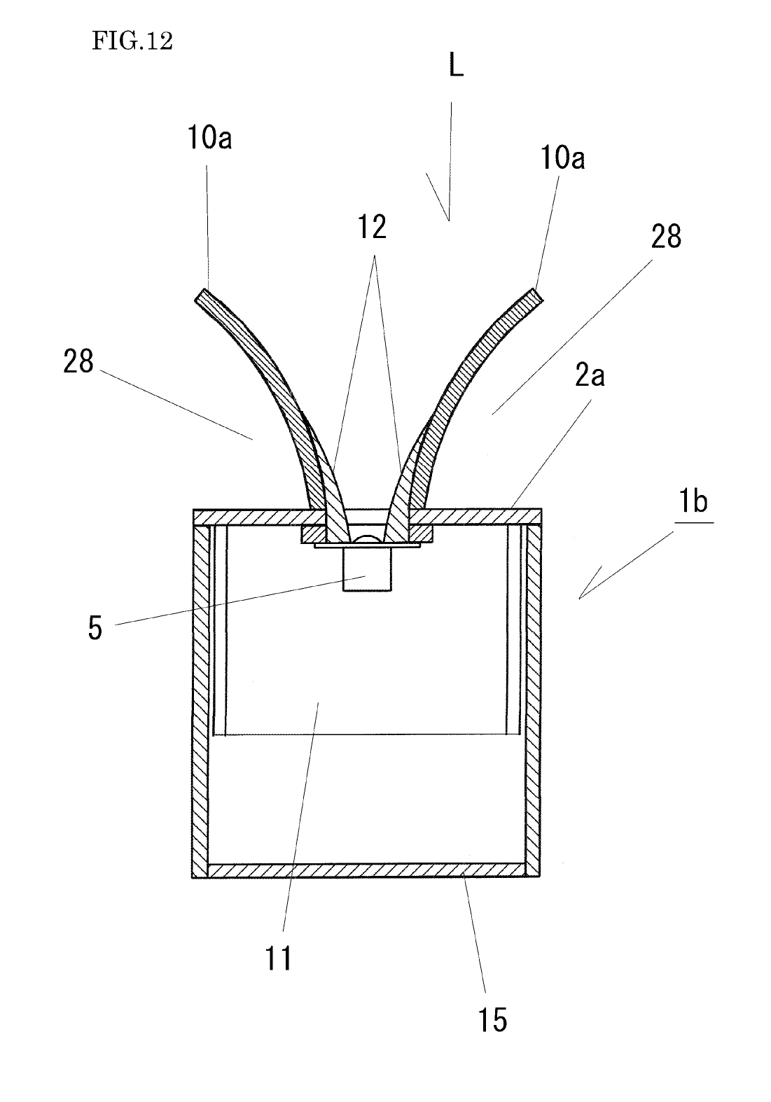

FIG. 13 is a graph of the frequency characteristics of the speaker devices in the second embodiment and a fourth comparative example.

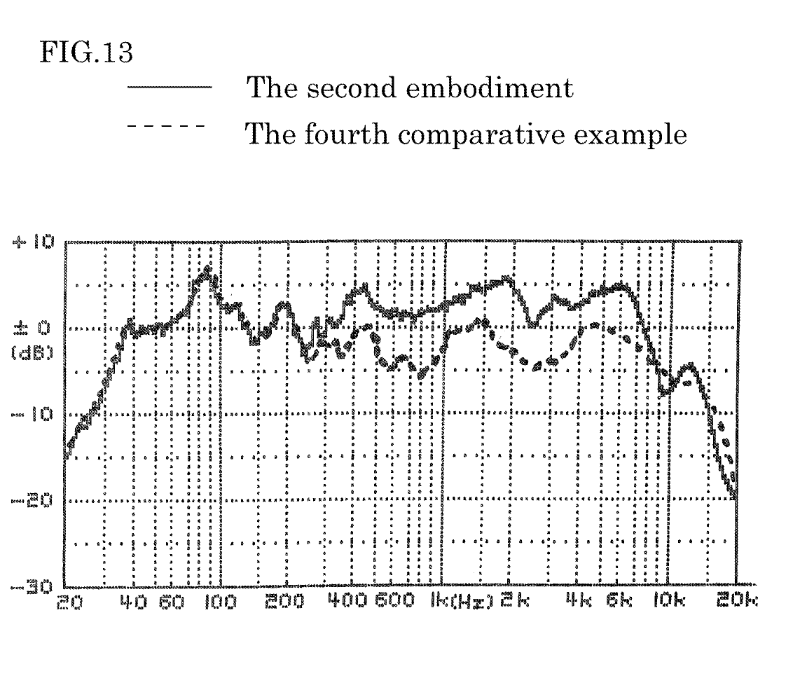

FIG. 14 is a perspective view of a speaker device 1c according to a third embodiment.

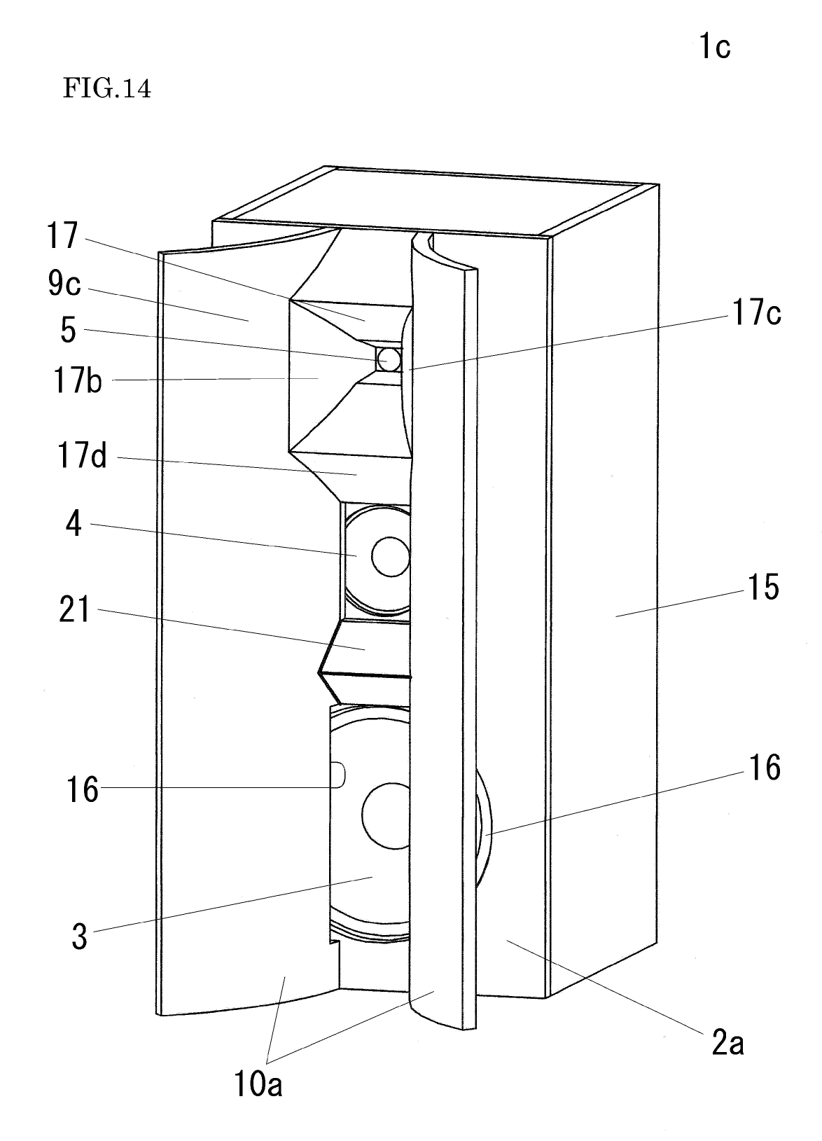

FIG. 15 is a perspective view of a speaker device 1d according to a fourth embodiment.

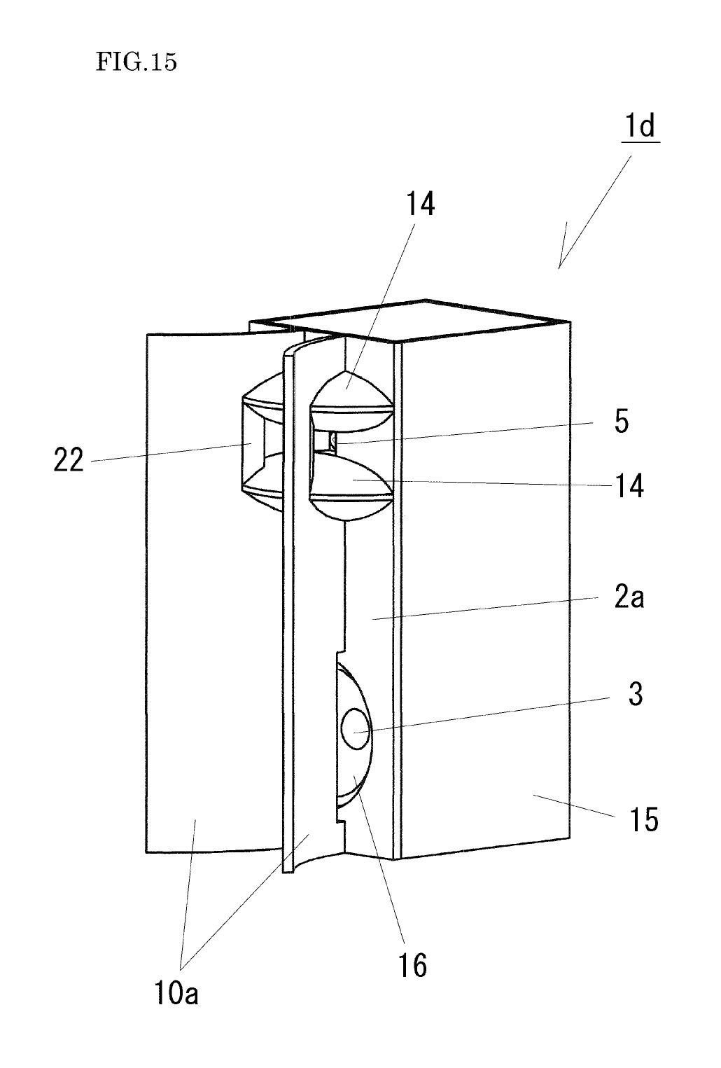

FIG. 16 is a sectional side view of the speaker device 1d of the fourth embodiment.

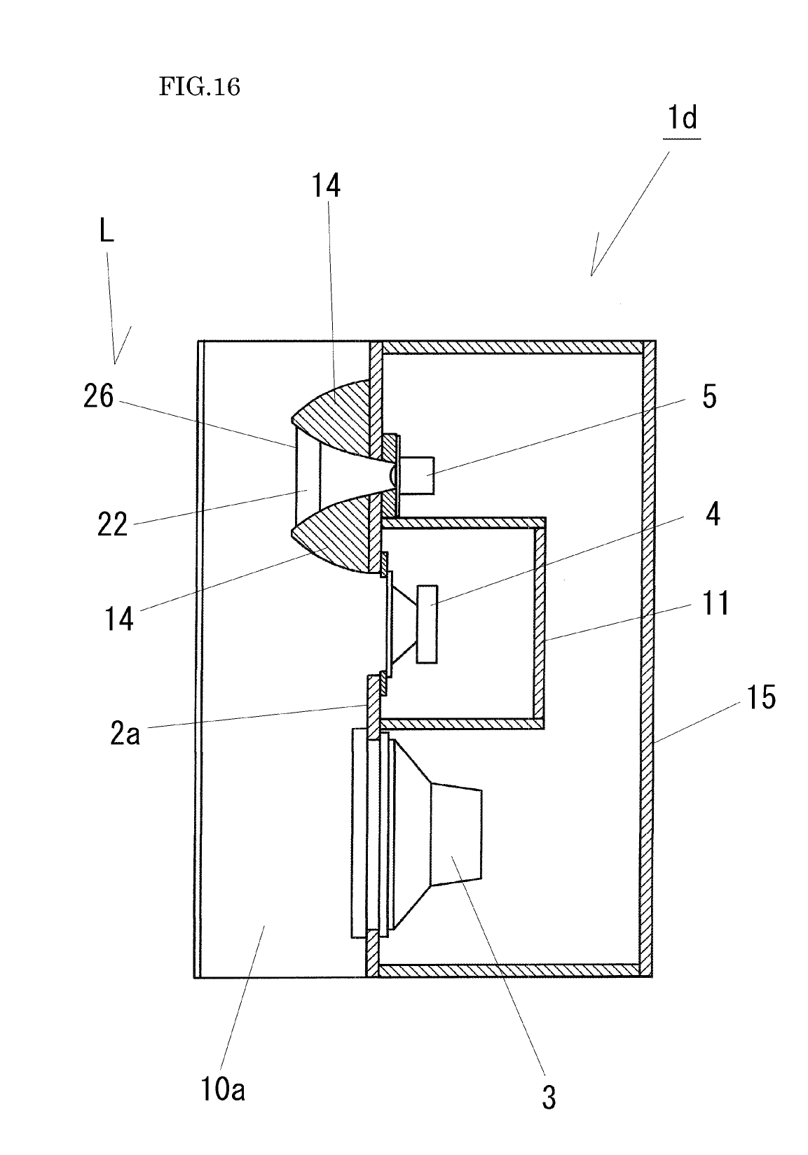

FIG. 17 is a laterally sectional view of the speaker device 1d at a height of a tweeter 5.

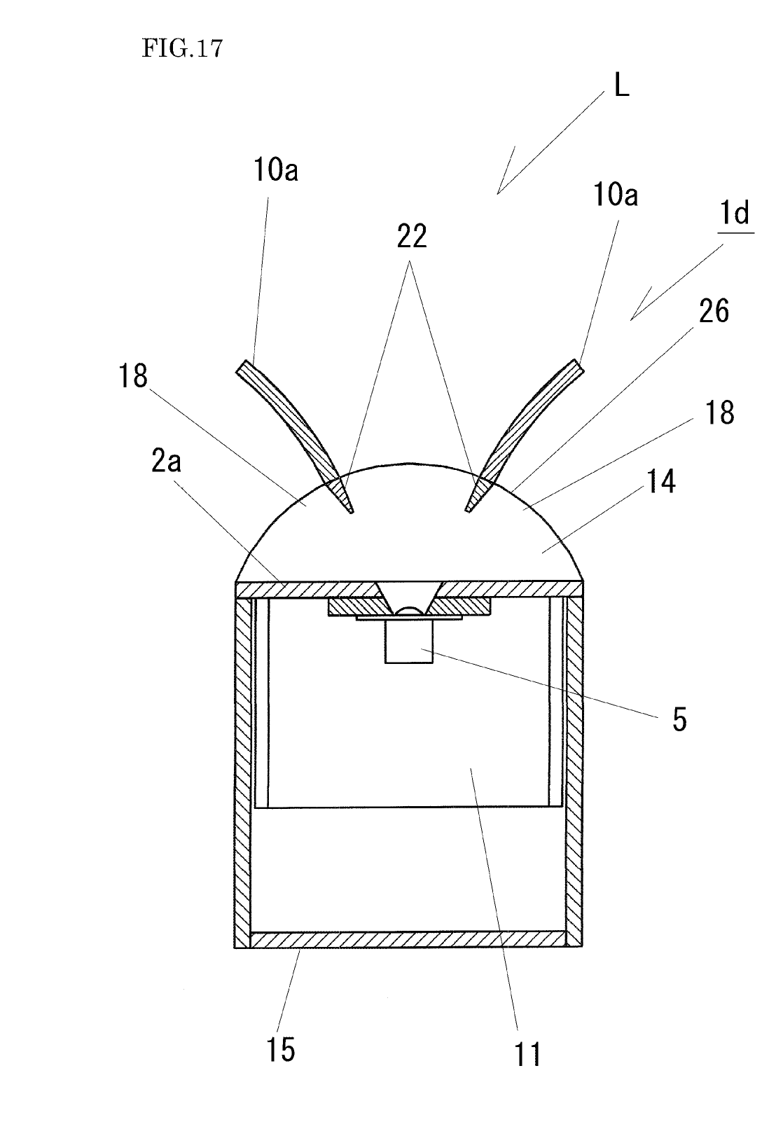

FIG. 18 is a perspective view of a speaker device 1e according to a fifth embodiment.

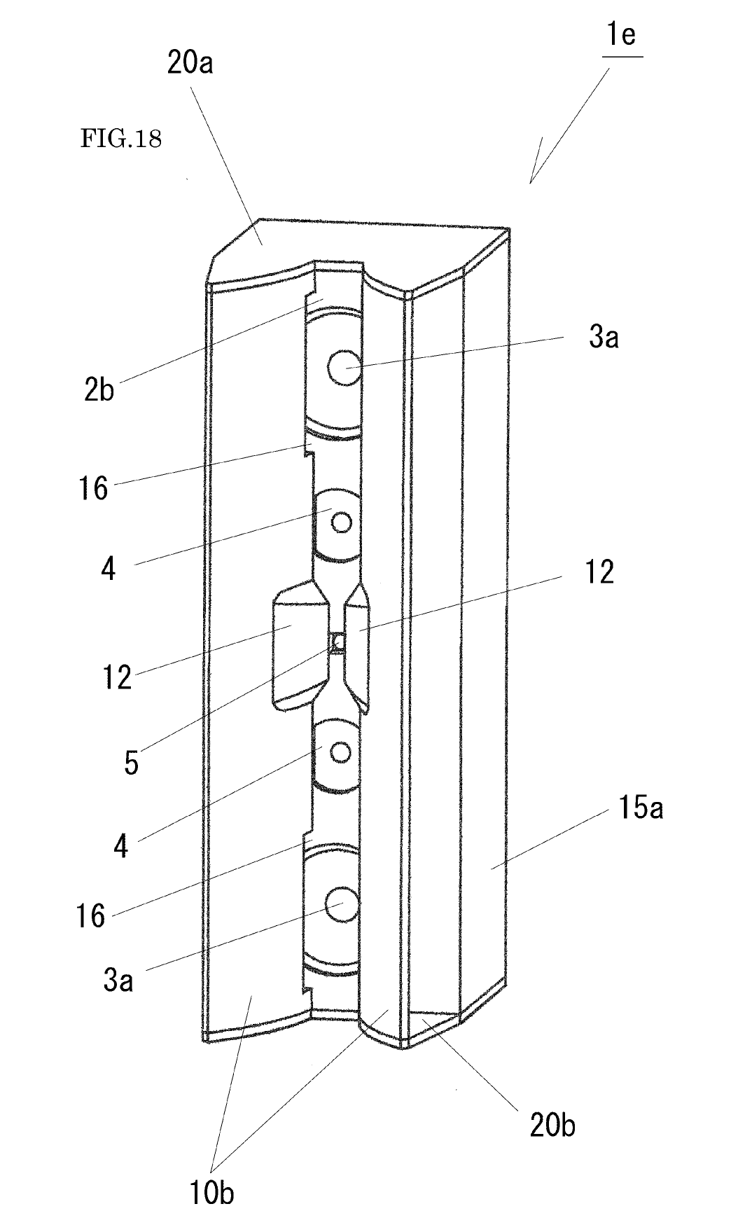

FIG. 19 is a perspective view of a speaker device 1f according to a sixth embodiment.

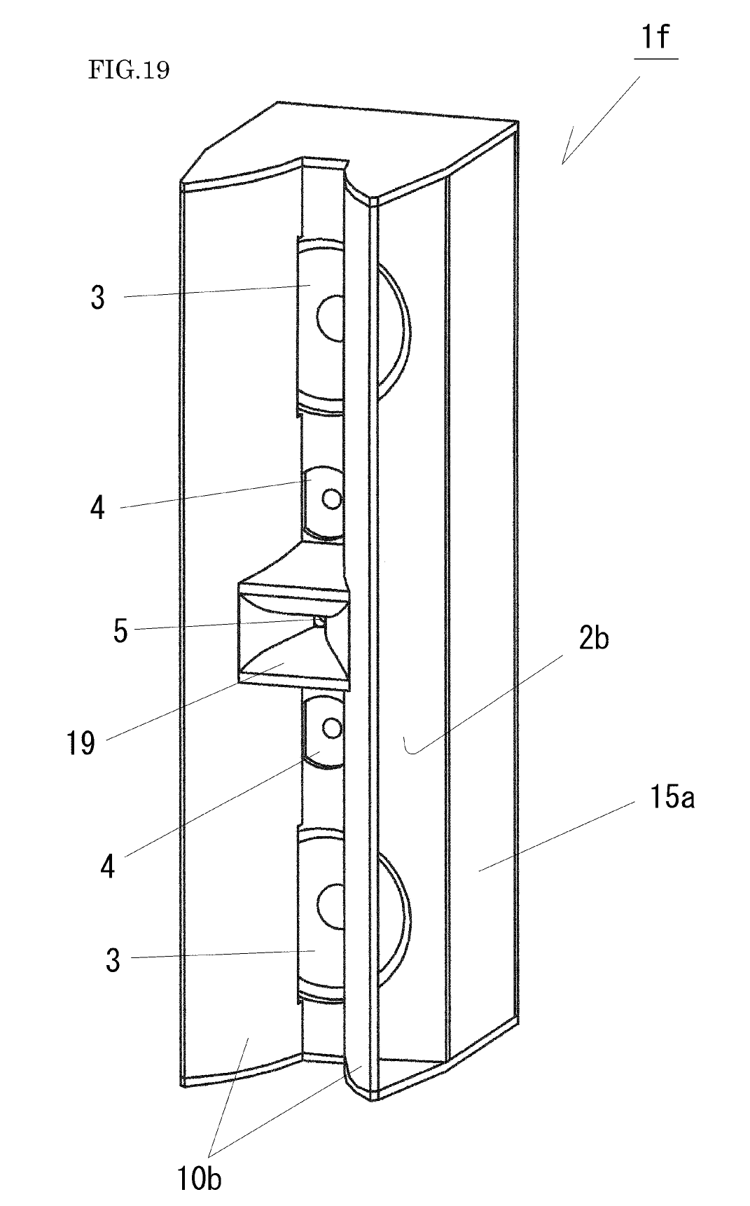

FIG. 20 is a sectional side view of the speaker device 1f.

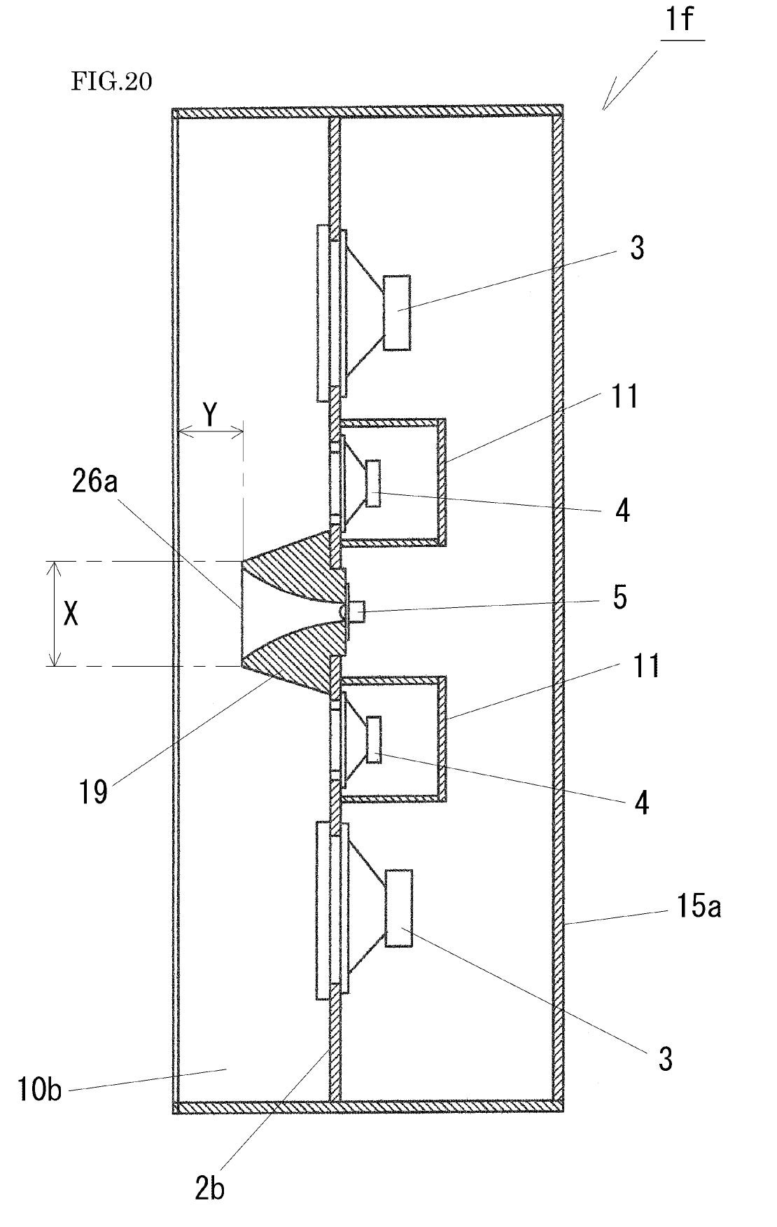

FIG. 21 is a perspective view of a speaker device 1g according to a seventh embodiment.

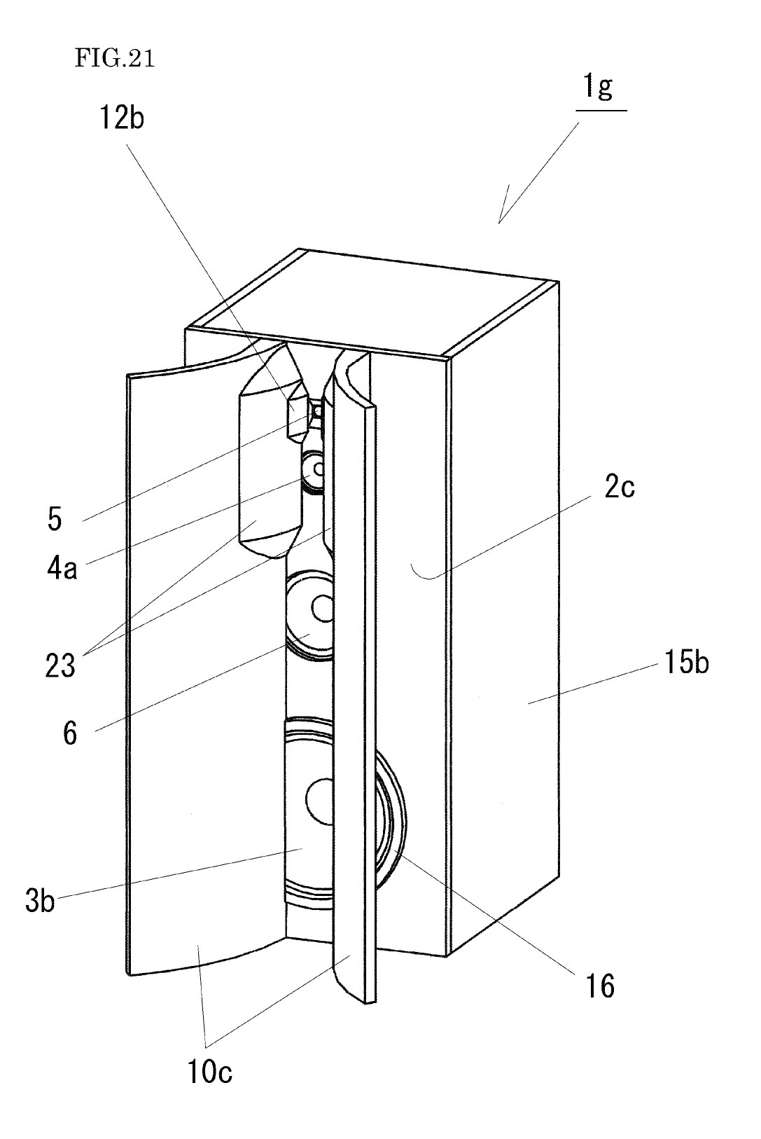

FIG. 22 is a perspective view of a speaker device 1h according to an eighth embodiment.

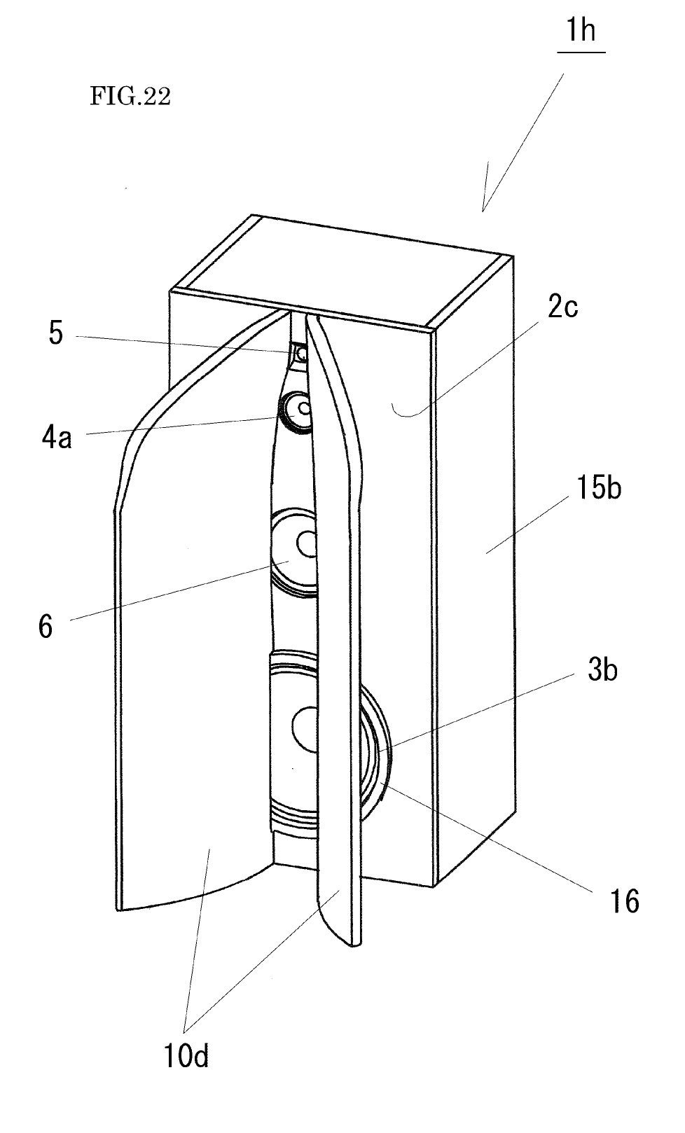

FIG. 23 is a plan view of the speaker device 1h of the eighth embodiment.

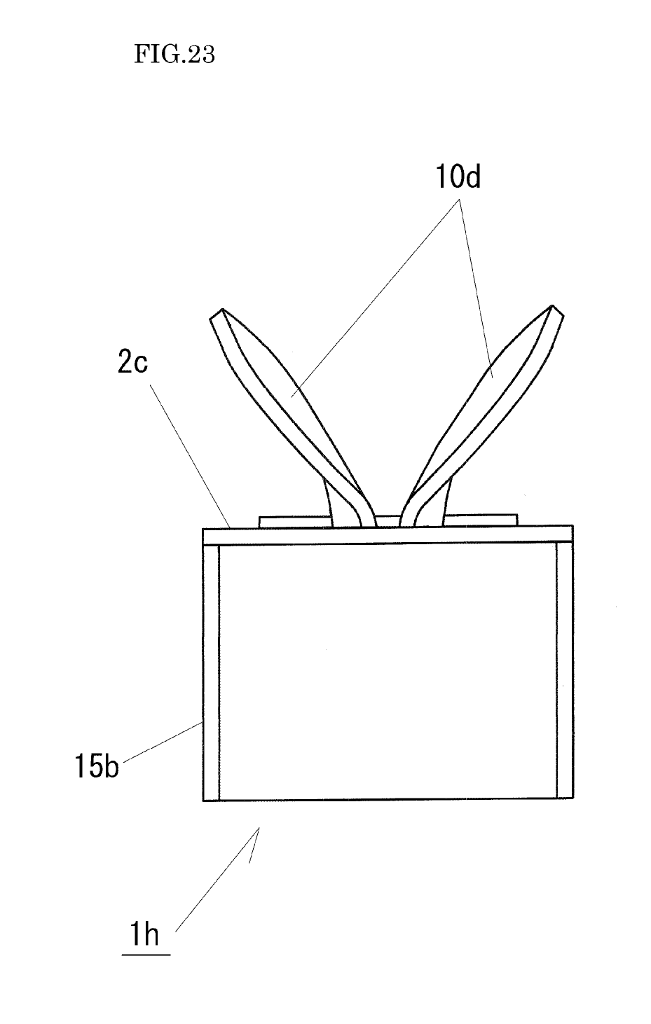

FIG. 24 is a perspective view of a speaker device 1i according to a ninth embodiment.

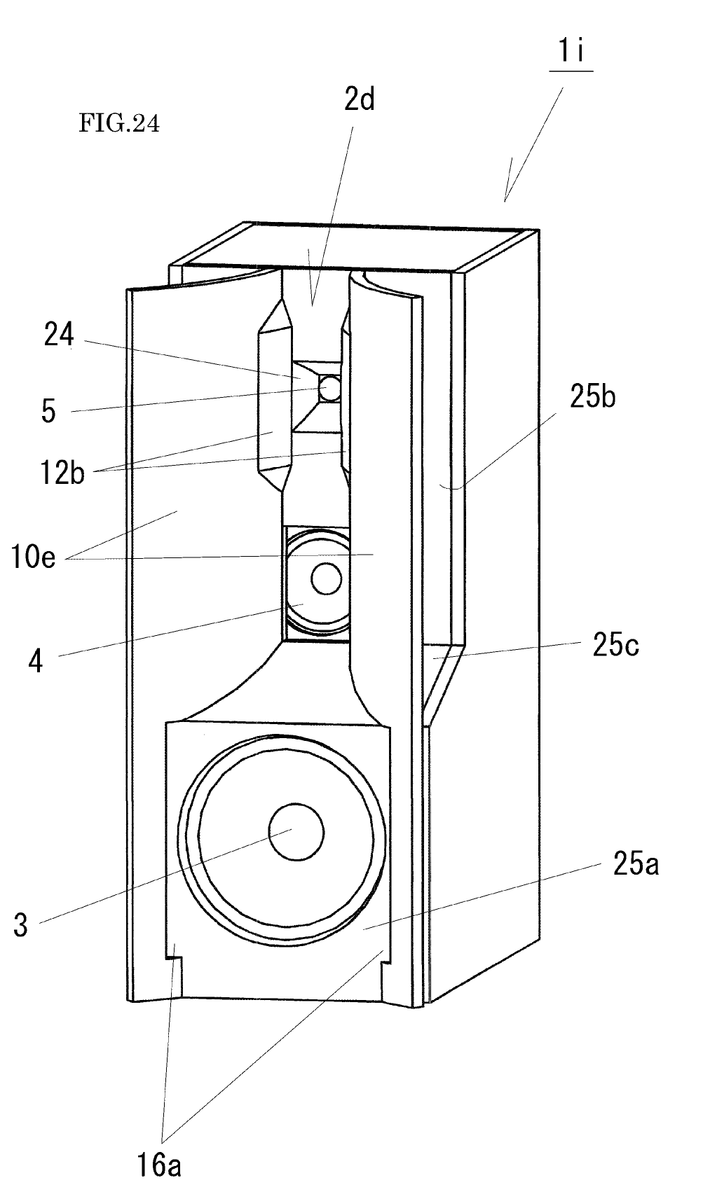

FIG. 25 is a perspective view of a speaker device 1j according to a tenth embodiment.

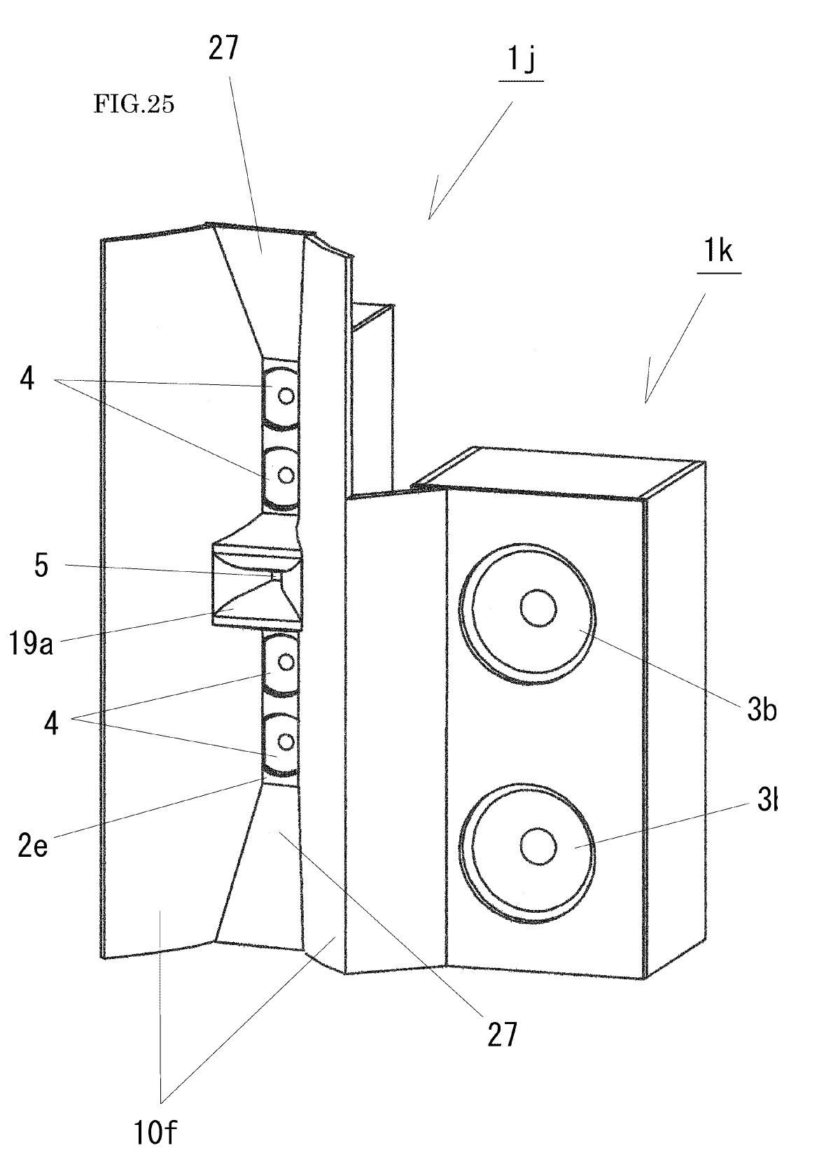

### DESCRIPTION OF REFERENCE NUMERALS AND SYMBOLS

1, 1a to 1k: speaker device
2, 2a to 2e: baffle board
3, 3a: woofer
4, 4a: squawker
5: tweeter
6: mid-bass
10, 10a to 10f: pair of enhanced walls
16, 16a: enhancement suppression gap
18: directivity widening gap
26, 26a: opening
28: outer vacancy

1. A speaker device in which two or more types of speaker with a different reproduction range are arranged in line on a baffle board, characterized in that:
a reference speaker for reproducing a high frequency range next to a reproduction range of a woofer is disposed on the baffle board; and a pair of enhanced walls is provided on the front side of the baffle board in such a manner that the pair of enhanced walls passes by both sides of a radiating face of the reference speaker and both sides of all the speakers other than the reference speaker, extends vertically along the front face of the baffle board, opens left and right toward the forward of the baffle and forms a shape to enhance a radiated sound from the reference speaker.

2. The speaker device according to claim 1, wherein a woofer is disposed on the baffle board, outer vacancies opening toward a listening space are formed between outer walls of the pair of enhanced walls and the front face of the baffle board, and enhancement suppression gaps are formed in the both side vicinities of the radiating face of the woofer to radiate the radiated sound from the woofer into the outer vacancies.

3. The speaker device according to claim 1, wherein
a horn-type tweeter for reproducing a higher frequency range than that of the reference speaker is disposed on the baffle board and
directivity widening gaps are formed in the both side vicinities of an opening of the horn of the horn-type tweeter to pass the radiated sound from the horn-type tweeter outside the pair of enhanced walls and radiate it into the listening space.

4. The speaker device according to claim 1, wherein
the horn-type tweeter, which reproduces a higher frequency range than that of the reference speaker, is disposed on the baffle board, the reference speakers are arranged virtually coaxial respectively above and below the tweeter, and
the opening of the horn of the tweeter is disposed behind the front end of the pair of enhanced walls by a distance more than a half of the vertical dimension of the opening.

5. The speaker device according to claim 1, wherein
the minimum distance through which the radiated sound from the reference speaker reaches an upper end of the pair of enhanced walls and the minimum distance through which the radiated sound from the reference speaker reaches a lower end of the pair of enhanced walls are generally equal to or longer than the minimum distance through which the radiated sound from the reference speaker reaches a front end of the pair of enhanced walls.

6. The speaker device according to claim 1, wherein
a speaker for high frequency range for reproducing a higher frequency range than that of the reference speaker is disposed on the baffle board and
a pair of enhanced walls for high frequency range is disposed in the both side vicinities of the radiating face of the speaker for high frequency range to open left and right toward forward and form in a shape to enhance the radiated sound, and the upper, the lower and the front ends of the pair of enhanced walls for high-frequency range are jointed with inner walls of the pair of enhanced walls.

7. The speaker device according to claim 1, wherein
a horn-type tweeter for reproducing a higher frequency range than that of the reference speaker is disposed on the baffle board and both sides of the front end of a horn of the horn-type tweeter are jointed with the inner walls of the pair of enhanced walls.

8. The speaker device according to claim 1, wherein
a speaker for high frequency range for reproducing a higher frequency range than that of the reference speaker is disposed on the baffle board and
the inner walls of the pair of enhanced walls pass by both side edges of the radiating face of the speaker for high frequency range and form in a shape to enhance the radiated sound from the speaker for high frequency range.
